(19) United States
(12) Patent Application Publication
(10) Pub. No.: US 2010/0220687 A1
(43) Pub. Date: Sep. 2, 2010

(54) SPECTRUM MANAGEMENT ACROSS DIVERSE RADIO ACCESS TECHNOLOGIES

(75) Inventors: Alexander Reznik, Titusville, NJ (US); Debashish Purkayastha, Pottstown, PA (US); Joseph A. Kwak, Hawkesbury (CA); Juan Carlos Zuniga, Montreal (CA); Tianming Li, Highland Park, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/703,142

(22) Filed: Feb. 9, 2010

Related U.S. Application Data
(60) Provisional application No. 61/151,422, filed on Feb. 10, 2009.
(60) Provisional application No. 61/234,870, filed on Aug. 18, 2009.

(51) Int. Cl. H04W 36/30; H04W 72/04

(52) U.S. Cl. 370/331; 370/329

(57) ABSTRACT

A network management node may manage a network of base stations and wireless transmit/receive units (WTRUs) that operate using diverse radio access technologies. The network management node may communicate with other network management nodes to manage spectrum usage across their respective managed networks. The network management node may acts as a proxy for cellular-capable WTRUs that operate within the managed networks. The network management node may perform handovers of Peer-to-Peer (P2P) groups that operate within the managed networks. The WTRUs may include WTRUs that operate at Very High Frequency (VHF) or Ultra High Frequency (UHF) spectrum (“white space”) frequencies.

### CROSS REFERENCES TO RELATED APPLICATIONS

This application claims the benefit of U.S. Provisional Application No. 61/151,422, filed on Feb. 10, 2009, and U.S. Provisional Application No. 61/234,870, filed on Aug. 18, 2009, each of which is hereby incorporated by reference herein in its entirety.

### TECHNICAL FIELD

The disclosed subject matter relates to wireless communications.

### BACKGROUND

Wireless transmit/receive units (WTRUs) may transmit using diverse radio access technologies, such as Code Division Multiple Access 2000 (CDMA200), Institute of Electrical and Electronics Engineers (IEEE) Wireless Local Area Network (WLAN), Universal Mobile Telecommunications System (UMTS) Terrestrial Radio Access Network (UTRAN), or other technologies. Current approaches do not adequately address how spectrum usage may be managed within a set of geographically proximate WTRUs that operate using diverse radio access technologies. For example, when the spectrum usage of a WTRU is controlled by the operator of a core network, the core network may not have data available regarding the spectrum usage of other WTRUs that operate using different radio access technologies in the vicinity of the WTRU. Spectrum usage within the set of WTRUs may therefore be sub-optimal.

Further, WTRUs may communicate using Very High Frequency (VHF) and Ultra High Frequency (UHF) spectrum (referred to as “white space”) frequency bands. Current approaches do not, however, adequately address spectrum management in white space frequencies. For example, unlicensed white space-capable WTRUs may be required to transition to different channels when licensed WTRUs are present on their channels. Current approaches do not address how these transitions should be managed in the context of diverse radio access technologies operating on white space frequencies.

Accordingly, spectrum usage may be improved by new technologies that address the above-listed shortcomings as well as other shortcomings of the current technologies.

### SUMMARY

A method for use in a network node may include receiving a service request form a WTRU. In response to the service request, the network node may send a message to a second network node, indicating a request that the second network node make a frequency band available. The network node may receive a message from the second network node, indicating that that the second network node has made the frequency band available. The network node may send a handover message to the WTRU, indicating that the WTRU should handover to the frequency band.

A network node may include at least one transceiver configured to receive a service request form a WTRU. The at least one transceiver may be configured to send a message to a second network node, indicating a request that the second network node make a frequency band available. The at least one transceiver may be configured to receive a message from the second network node, indicating that that the second network node has made the frequency band available. The at least one transceiver may be configured to send a handover message to the WTRU, indicating that the WTRU should handover to the frequency band.

A network node may include a processor configured to make a determination to handover a Peer-To-Peer (P2P) group of WTRUs from a first radio access network to a second radio access network. The network node may further include a transmitter configured to send handover messages to the WTRUs in the P2P group. The handover messages may indicate that the WTRUs in the P2P group should handover to the second radio access network.

### BRIEF DESCRIPTION OF THE DRAWINGS

A more detailed understanding may be had from the following description, given by way of example in conjunction with the accompanying drawings wherein:

FIG. 1 shows an example architecture for inter-radio access technology spectrum and handover management;

FIG. 2 shows a network management node;

FIGS. 3A-3B show an example method for the registration of a WTRU with a network management node;

FIG. 4 shows an example method for the registration of a WTRU with a network management node, wherein the WTRU moves from a macrocell to a femtocell managed by a network management node;

FIG. 5 shows an example method for the registration of a WTRU with a network management node via the Internet;

FIGS. 6A-6B show an example method for the handover of a WTRU from a macrocell to a radio access network within the management network of a network management node;

FIGS. 7A-7B show an example method for the handover of a WTRU from a radio access network within a managed network to a macrocell;

FIGS. 8A-8B show an example method for handover of a WTRU between radio access networks in a managed network;

FIGS. 9A-9C show an example method for handover of WTRUs in a Peer-To-Peer (P2P) group between radio access networks in a managed network;

FIGS. 10A-10D show an example method for spectrum management performed by network management nodes;

FIG. 11 shows an example method for the generation and communication of a spectrum utilization map by a network management node;

FIG. 12 shows an example method for upper-layer handover execution;

FIG. 13 shows an example method for the establishing a local data relay in a managed network;

FIG. 14 shows an example method for establishing a Wide Area Network (WAN) relay connection in a managed network;

FIG. 15 shows an example method for the deregistration of a WTRU with a network management node;

FIG. 16 shows an example architecture for the management of spectrum usage in the context of white space-capable WTRUs;

FIG. 17 shows Service Access Points (SAPs) that may be used for the management of spectrum usage in the context of white space-capable WTRUs; and

FIG. 18 shows an example wireless communication system that may be configured to perform methods and features described with reference to FIGS. 1-17.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of device capable of operating in a wireless environment. [0001] When referred to hereafter, the terminology “base station” includes but is not limited to a Node-B, an e-NodeB, a Home NodeB (NHB), a Home eNodeB (HeNB), a site controller, an access point (AP), or any other type of interfacing device capable of operating in a wireless environment.

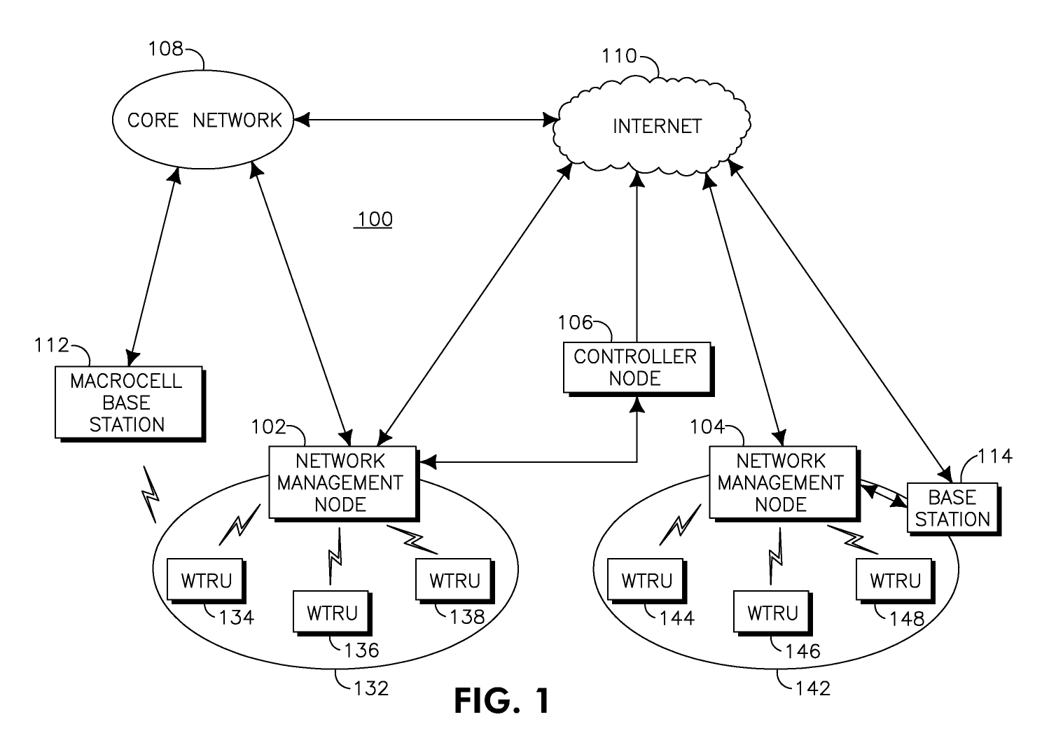

FIG. 1 shows an example architecture 100 for inter-radio access technology spectrum and handover management. The example architecture 100 may include a first network management node 102, a macrocell base station 112, a second network management node 104, and a controller node. The first network management node 102 may manage WTRUs 134, 136, 138 in the first managed network 132. The second network management node 104 may manage WTRUs 144, 146, 148 in the second managed network. The example architecture 100 may further include a core network 108, and the Internet 110. The core network 108 may be a cellular core network and may be based on, for example, System for Mobile Communications (GSM), Long Term Evolution (LTE)/Service Architecture Evolution (SAE), UMTS, CDMA2000, IEEE 802.16, and/or other technologies.

The first network management node 102 may coordinate the activities of the WTRUs 134, 136, and 138 in the first managed network 132. Each or any of the WTRUs 134, 136, 138 may be multi-mode WTRUs, capable of communicating using two or more wireless access technologies. The first network management node 102 may include one or more radio access units that provide one or more air interfaces to the WTRUs 134, 136, 138. The radio access units may be base stations, and/or may include circuitry configured to perform base station functionality. Each of the WTRUs 134, 136, 138 may communicate with the first network management node 102 directly via one or more of the air interfaces. Alternatively, one or more of the WTRUs 134, 136, 138 may communicate with the first network management node 102 indirectly by relaying data through any of the other WTRUs 134, 136, 138. The first network management node 102 may be connected to the Internet 110, and the WTRUs 134, 136, 138 may transmit data to and/or receive data from the Internet 110 via the first network management node 102.

A first WTRU 134 in the first managed network 132 may additionally communicate with a macrocell base station 112. The first WTRU 134 may transmit data to and/or receive data from the core network 108 via the macrocell base station 112. The first WTRU 134 may also receive data from the Internet 110 via the core network 108 and the macrocell base station 112. Alternatively or additionally, the first network management node 102 may communicate with the core network 108. This may be, for example, when the first network management node 102 includes a radio access unit that implements a femtocell that is managed by the core network 108. The first WTRU 134 may transmit data to and/or receive data from the core network 108 via the first network management node 102. The first WTRU 134 may also receive data from the Internet 110 via the core network 108 and the first network management node 102.

The second network management node 104 may coordinate the activities of the WTRUs 144, 146, and 148 and the base station 114 in the second managed network 142. Each or any of the WTRUs 144, 146, 148 may be multi-mode WTRUs, capable of communicating using two or more wireless access technologies. The second network management node 104 may include one or more radio access unit that provide one or more air interfaces to the WTRUs 144, 146, 148. The radio access units may be base stations, and/or may include circuitry configured to perform base station functionality. Each of the WTRUs 144, 146, 148 may communicate with the second network management node 104 directly via one or more of the air interface. Alternatively, one or more of the WTRUs 144, 146, 148 may communicate with the second network management node 104 indirectly by relaying through any of the other WTRUs 144, 146, 148. The second network management node 104 may be connected to the Internet 110, and the WTRUs 144, 146, 148 may transmit data to and/or receive data from the Internet 110 via the second network management node 104.

A second WTRU 144 in the second managed network 142 may additionally be in communication with a base station 114. The second WTRU 144 may transmit data to and/or receive data from the Internet 110 via the base station 114. The base station may be, for example, a WLAN base station, femtocell base station, or other type of base station. The second WTRU 144 may receive data from the Internet 110 via the base station 114.

Each or any of the WTRUs 134, 136, 138, 144, 146, 148 may have a sensing capability and may obtain information about spectrum utilization on the radio access network on which it is communicating. The WTRUs 134, 136, 138, 144, 146, 148 may report the spectrum utilization information to their respective network management nodes 102, 104. The WTRUs 134, 136, 138, 144, 146, 148 may additionally be able to obtain information related to locations and/or transmission powers of other WTRUs operating on the same access networks as those on which they are operating. The WTRUs 134, 136, 138 may additionally be able to communicate this information to their respective network management nodes 102, 104.

Each or any of the WTRUs 134, 136, 138, 144, 146, 148 may be able to negotiate with each other WTRUs in their respective managed networks 132, 142 to achieve optimized transmission powers, so as to improve QoS in the managed networks 132, 142. One or more of the WTRUs 134, 136, 138, 144, 146, 148 may act as brokers for others of the WTRUs in their respective managed networks 132, 142 that use different radio access technologies. For example, a WLAN-capable WTRU may wish to communicate with a Bluetooth device. A dual-mode radio can act as their broker for coordinating this communication. Further, some WTRUs can be assigned as relay nodes for devices that do not have Wide Area Network (WAN) access. One or more of the WTRUs 134, 136, 138, 144, 146, 148 may communicate using peer-to-peer (P2P) technologies with other WTRUs in their respective managed networks 132, 142. Peer-to-peer communications by the WTRUs 134, 136, 138, 144, 146, 148 may be managed by their respective network management nodes 102, 104.

Before any of the WTRUs 134, 136, 138 are permitted to access a radio access network within the first managed network 132 of the first network management node 102, the first network management node 102 may require the WTRUs 134, 136, 138 to register and authenticate with the first network management node 102. If any of the WTRUs 13, 136, 138 move to a different a radio access network within the first managed network 132, the WTRUs may re-register with the first network management node 102 on their new radio links. The second network management node 104 may similarly require that WTRUs 144, 146, 148 in the second managed network 142 register prior to accessing a radio access network within the second managed network 142.

The controller node 106 may manage spectrum utilization across multiple network management nodes, such as the first network management node 102 and the second network management node 104. Each network management node 102, 104 coordinated by the controller node 106 may register with and de-register from the controller node 106.

The network management nodes 102, 104 may send information to the controller node 106 related to spectrum utilization of the network management nodes 102, 104 and/or of any of the devices 114, 134, 136, 138, 144, 146, 148 in the networks 132, 142 managed by the network management nodes 102, 104.

The controller node 106 may analyze the spectrum utilization information obtained from the network management nodes 102, 104, and may adjust a spectrum usage policy based on the spectrum utilization information, so as to optimize spectrum usage across the first and second managed networks 132, 142. The spectrum usage policy may indicate, for example, what frequency bands should be used in the first managed network 132 and/or the second managed network 142. The spectrum usage policy may be based on factors such as the radio access technologies being used in the managed networks 132, 142. The spectrum usage policy may be updated by the controller node 106 when a new radio access technology is used in one of the managed networks 132, 142, when frequency usage conditions in one of the managed networks changes 132, 142, and/or in periodic intervals. The controller node 106 may update the spectrum usage policy, for example, every four hours, once per day, or at some other interval. When the spectrum usage policy is updated, the controller node 106 may send one or more messages to the network management nodes 102, 104, indicating that the network management nodes 102, 104 should manage spectrum usage in their respective managed networks 132, 142 according to the spectrum usage policy.

In various implementations, functionality described above as performed by the controller node 106 may be performed by one or more of the network management nodes 102, 104. The network management nodes 102, 104 may communicate spectrum utilization information directly between themselves 102, 104, and may cooperate to achieve optimal spectrum usage across their respective managed networks 132, 142.

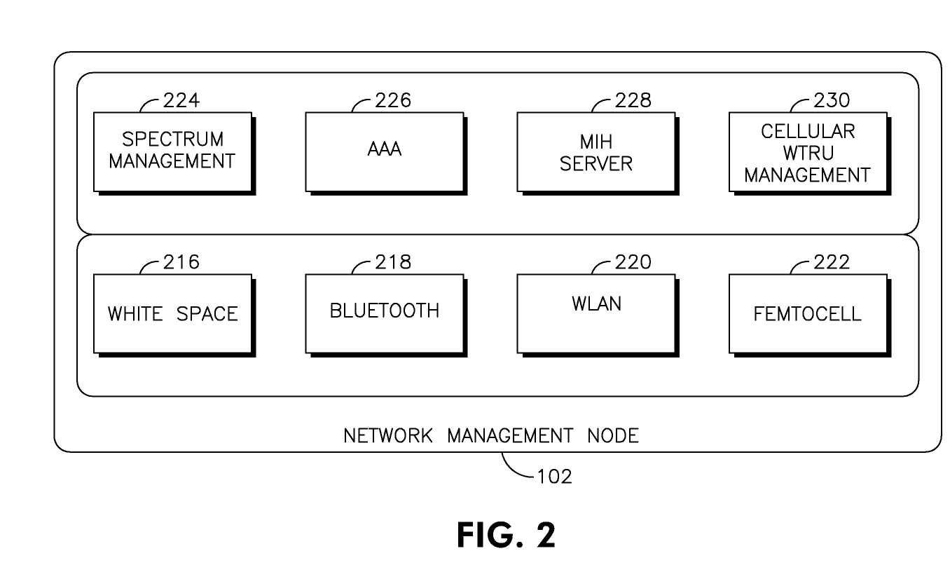

FIG. 2 shows a more detailed view of the first network management node 102 of FIG. 1. The first network management node 102 may include a spectrum management unit 224, an Authentication, Authorization, and Accounting (AAA) unit 226, an MIH server unit 228, a cellular WTRU management (CWNI) unit 230. The MIH server unit 228 may perform functions related to the MIH event, command, and/or information services, as well as other functions described in further detail herein.

The first network management node 102 may further include an MIH messaging unit (not depicted) and/or an Internet Protocol (IP) unit (not depicted). The MIH messaging unit may implement MIH signaling and protocols. The MIH messaging unit may be used to generate and/or process MIH messages that are sent and/or received at the first network management node 102 via lower-layer signaling. The IP unit may implement IP, and may be used to generate and/or process packet data that is sent and/or received at the first network management node via lower-layer signaling.

The first network management node 102 may further include one or more radio access units 216, 218, 220, 222 that implement one or more radio access technologies. By way of example, the first network management node 102 may include a WLAN unit 220, a Bluetooth unit 218, a white space unit and a femtocell unit 222. The femtocell unit 222 may implement functionality according to a femtocell, picocell, microcell, or other local-area base station such as a HNB or a HeNB. Each of the radio access units 216, 218, 220, 222 may include circuitry, software, or a combination thereof, configured to implement Layer One and/or Layer Two interfaces for their respective radio access technologies. Although the first network management node 102 is shown as including four radio access units 216, 218, 220, 222, a network management node may include any number of radio access units, including zero.

The first network management node 102 may manage WTRUs that operate using multiple diverse radio access technologies. Different applications running on the different WTRU may have different priority levels and Quality of Service (QoS) requirements. For example, Voice over IP (VoIP) and streaming video applications require low delay jitter and latency. Medical monitoring and security monitoring applications may require high priorities. The spectrum management unit 224 may manage QoS requirements across the different WTRUs managed by the first network management node 102. The spectrum management unit 224 does so by, for example, managing and coordinating spectrum utilization among WTRUs in order to provide guaranteed QoS to different applications.

For example, when a radio access network used by the WTRUs managed by first network management node 102 is busy, the spectrum management unit 224 may determine that lower-priority WTRUs should be handed over to different access networks. The spectrum management unit 224 may communicate with the MIH server unit 228 to provide appropriate commands to the WTRUs to initiate handover to the different access networks.

The spectrum management unit 224 may additionally manage wireless traffic related to Peer-to-Peer (P2P) communication. For example, one or more WTRUs may send messages to the first network management node 102 indicating that they are initiating a wireless local network game. The first network management node 102 may send response messages to the WTRUs, indicating that they should operate on a particular frequency band and/or radio access network for traffic related to the game.

A user of first network management node 102 may set priorities and/or otherwise configure the policies used at the spectrum management unit 224 for spectrum management. This may facilitate usage tailored to the needs of the user. For example, when the user of first network management node 102 is a teenager, they may be able to set the priority of a health monitor WTRU to a low priority and set the priority of a gaming device to a high priority. However, an elderly user may wish to set the health monitor device as having a high priority and the gaming device as having a low priority. Alternatively or additionally, the spectrum management unit 224 may configured spectrum management policies based on the preferential usage of one radio access network versus another. For example, preferential usage may be based on different costs and/or data rates associated with different ratio access networks.

First network management node 102 may additionally receive spectrum usage reports from the WTRUs it is managing, and the spectrum management unit 224 may process and/or store the spectrum usage reports. The reports may relate, for example, to spectrum bands being used on the different WTRUs and QoS on the spectrum bands. The spectrum management unit 224 may construct a spectrum map based on the reports, and use the spectrum map for spectrum management.

Alternatively or additionally, the first network management node 102 may measure spectrum utilization in its vicinity, across the diverse access networks being used by the WTRUs in the first managed network 132. This may be performed by the spectrum management unit 224 in conjunction with, for example, one or more of the radio access units 220, 218, 216, 222 in first network management node 102. This may additionally be performed in conjunction with any base stations with which first network management node 102 is in communication. If first network management node 102 does not include any radio access units, this may be based solely on data received from base stations with which first network management node 102 is in communication. The spectrum management unit 224 may receive this spectrum utilization information, and may perform spectrum management based on the spectrum utilization information.

In addition to or as an alternative to the information related to spectrum management described above, the spectrum management unit 224 may store spectrum utilization information such as: which frequency bands are being used in the first managed network 132; QoS conditions on the different frequency bands being used in the first managed network 132; which radio access technologies are being used in the first managed network 132; or which radio access technologies are being used on which frequency bands in the first managed network 132. The spectrum management unit 224 may communicate spectrum utilization information to the controller node 106. For example, the spectrum management unit 224 may respond to queries for spectrum utilization information from the controller node 106. Alternatively or additionally, the first network management node 102 may send spectrum utilization information to the controller node 106 on a periodic basis. The time intervals between transmissions of the spectrum utilization information may be based on a policy set in the spectrum management unit 224, and/or may be based on signaling between the controller node 106 and the spectrum management unit 224.

The spectrum management unit 224 may operate in a mandatory mode, an advisory mode, or a mode that is a combination of both. In the mandatory mode, whenever a WTRU wishes to use some spectrum, it notifies the first network management node 102. The spectrum management unit 224 may approve the use of the spectrum by the WTRU. The WTRU may then occupy the spectrum and receive services. In the advisory mode, the spectrum management unit 224 may provide information regarding whether a WTRU should use spectrum. This may be based on, for example, link conditions as related to the spectrum the WTRU has requested to use. This information may not be interpreted by the WTRU as a command, however, and the WTRU may or may not access the requested spectrum. In the combination mode, first network management node 102 generally acts as in mandatory mode, but may be configured to make exceptions for specific WTRUs. The spectrum management unit 224 may additionally take into account that emergency services should be available to any WTRUs that wish to access them.

The spectrum management unit 224 in the first network management node 102 may manage how WTRUs being managed by the first network management node 102 access WANs. For example, when a WTRU wants to gain access to a WAN (such as a cellular network), the spectrum management unit 224 may provide suggestions or mandatory commands to the WTRU. The suggestions or mandatory commands may be based on, for example, real-time network traffic conditions and/or a spectrum management policy. As an example, a WTRU being managed by the first network management node may send a message indicating that the WTRU would like to connect to the Internet. The CWM may determine based on network traffic conditions and/or a spectrum management policy as to whether the WTRU should connect to the Internet via a macrocell base station or via an air interface provided by the first network management node.

The spectrum management unit 224 may also act as a spectrum broker for WTRUs that cannot access a WAN. For example, a WTRU that is capable of communicating using only a local-area technology such as Bluetooth may send a request to the first network management node 102 to request access to a WAN. The spectrum management unit 224 would process the message, and would help the WTRU find another WTRU that it may use as a relay to obtain WAN access.

The AAA unit 226 may perform tasks related to the authentication, authorization, and/or registration of WTRUs managed by the first network management node 102. When a WTRU registers with the first network management node 102, the AAA unit 226 may receive authentication and/or credential information from the WTRU, and may use the authentication and/or credential information to determine if the WTRU should be granted access to the radio access network managed by the first network management node 102.

The CWM unit 230 may manage information related to cellular-capable WTRUs. For example, the CWM unit 230 may maintain a list of cellular-capable WTRUs that are permitted to access the first network management node 102. Alternatively or additionally, the CWM unit 230 may maintain a list of cellular WTRUs that are currently in communication with the first network management node 102 at a given time.

When a cellular-capable WTRU connects to the first network management node 102 via one of the radio access units that does not have a link to a cellular core network (such as, for example, the white space unit 216, the Bluetooth unit 218, or the WLAN unit 220), the CWM unit 230 may act as a proxy and register the cellular-capable WTRU with a cellular core network via a link between the femtocell unit 222 and the cellular core network. The CWM unit 230 may receive information required to authorize the cellular-capable WTRU to access the first network management node 102, and map the authorization information to authorization information required to access the cellular core network. The CWM unit 230 may then transmit the cellular core network authorization information to the cellular core network via the femtocell, thereby registering the WTRU with the cellular core network. Using this approach, the cellular-capable WTRU is not required to register with the cellular core network via a macrocell.

In various implementations, it may be undesirable for the CWM unit 230 to register the cellular-capable WTRU with the cellular network if the WTRU is already registered with the cellular network. Therefore, the registration information provided by the cellular-capable WTRU may include an indication of whether the WTRU is already registered with the cellular network or not. Alternatively or additionally, the CWM unit 230 may store one or more parameters that indicate whether a cellular WTRU has been previously registered with the cellular network.

Alternatively or additionally, when a cellular-capable WTRU connects to the femtocell unit 222, the CWM unit 230 may use the registration and/or authentication information related to the cellular core network to register the cellular-capable WTRU with the AAA unit 226. The CWM unit may receive the registration and/or authorization information from the femtocell unit 222 during the registration process.

The first network management node 102 may additionally include a database unit (not depicted). The database unit may be used by the other units 216, 218, 220, 222, 224, 226, 228, 230 in the network management node, for the storage of information related to the functions the other units 216, 218, 220, 222, 224, 226, 228, 230 perform. The database unit may store information for the other units 216, 218, 220, 222, 224, 226, 228, 230 in one or more computer-readable storage media (not depicted) in the first network management node 102.

Each of the units 216, 218, 220, 222, 224, 226, 228, 230 in the first network management node may be implemented as a circuit, combination of circuits, a software module, a firmware module, or as a combination of software, firmware, and/or one or more circuits. Alternatively or additionally, any combination or sub-combination of the units 216, 218, 220, 222, 224, 226, 228, 230, may be implemented across any combination of circuits, software modules, and/or firmware modules.

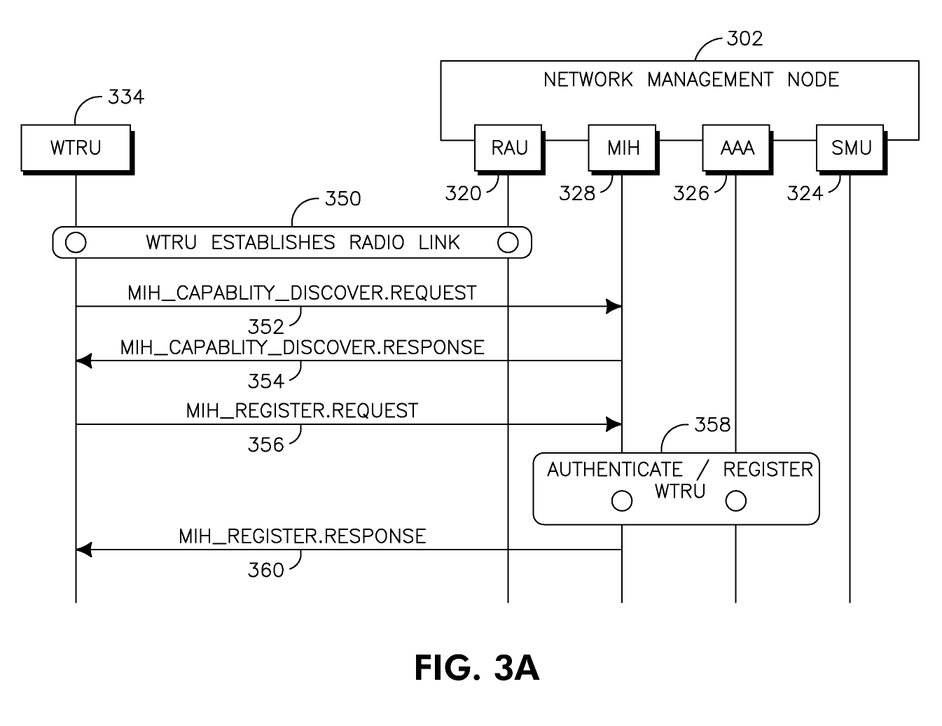

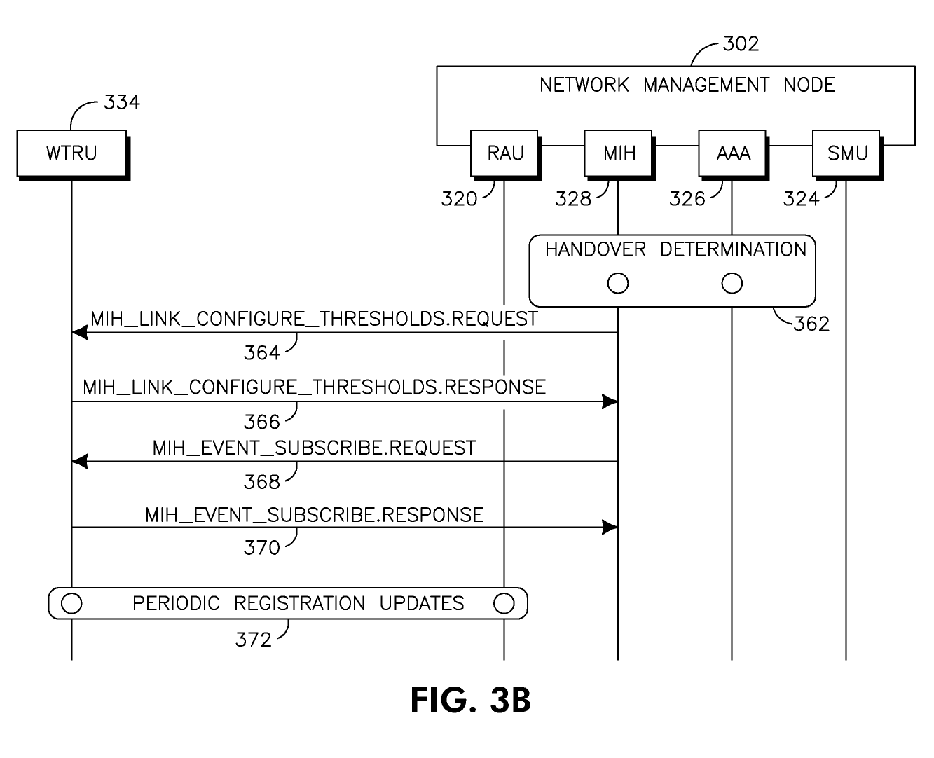

FIGS. 3A-3B show an example method for the registration of a WTRU 334 with a network management node 302. The network management node 302 may include a radio access unit (RAU) 320, an MIH server unit 328, a AAA unit, and a spectrum management unit (SMU) 324.

The method of FIGS. 3A-3B may begin as shown in FIG. 3A with the WTRU 334 establishing a radio link to the radio access unit 320 (step 350). The establishment of the radio link may be initiated by the WTRU 334 in response to detecting the radio access network provided by the radio access unit 320. Establishing the radio link may include Layer One and/or Layer Two signaling required to establish a radio link according to the radio access technology implemented by the radio access unit 320. This may also include discovery, handshaking, authentication, and/or other signaling involved to establish a radio link according to the radio access technology implemented by the radio access unit 320. For example, if the radio access unit 320 is a WLAN radio access unit, the WTRU 334 and the radio access unit 320 may establish a radio link according to a WLAN protocol.

The WTRU 334 may then send a capability discovery message to the MIH server unit 328 in the network management node 302, indicating MIH capabilities of the WTRU 334 (step 352). The capability discovery message may be, for example, an MIH_Capability_Discover.request message. The capability discovery message may indicate whether the WTRU 334 supports the MIH event service, the MIH command service, and/or the MIH information service. The capability discovery message may also include a list of radio access technologies supported by the WTRU 334. The capability discovery message may also indicate, for each supported radio access technology, which types of link events and/or what kind of measurement reporting is supported by the WTRU 334. This information may be included in, for example, a RATEventList field in the capability discovery request message. The capability discovery message may also include one or more fields that indicate a list of radio access technologies supported by the WTRU 334 and, for each supported radio access technology, which types of link commands are supported by the WTRU 334. This information may be included, for example, in a RATCMDList field in the capability discovery message.

The MIH server unit 328 may send a capability discovery response message to the WTRU 334 (step 354). The capability discovery response message may be, for example, an MIH_Capability_Discover.response message. The capability discovery response message may indicate the radio access networks that are managed by the network management node 302. The capability discovery response message may also indicate, for each managed radio access network, the radio access technology implemented by the radio access network, a Point of Attach (PoA) link address for the base station or radio access unit that provides the radio access network, and/or location information for each radio access network. In an instance where the WTRU 334 and network management node 302 operate in a building or other facility that has room numbers or other location identifiers, the location information may indicate a room number or other location identifier. The capability discovery response message may also indicate whether the MIH server unit 328 supports the MIH event service, the MIH command service, and/or the MIH information service.

The WTRU 334 may then send a registration request message to the MIH server unit 328 (step 356). The registration request message may be, for example, an MIH_Register.request message. The registration request may include one or more fields that indicate a request for one or more MIH services, such as the MIH event service, MIH command service, and/or the MIH information service. The registration request may also include a security code that may be used to authenticate the WTRU 334. The security code may be included, for example, in a DeviceInfo field in the registration request message.

Alternatively or additionally, the registration request message may also include location information that describes the location of the WTRU 334. The location information may indicate, for example, Global Positioning System (GPS) location coordinates. In an instance where the WTRU 334 and network management node 302 operate in a building or other facility that has room numbers or other location identifiers, the location information may indicate a room number or other location identifier. The location information may be included, for example, in a LocationInfo field in the registration request message.

Alternatively or additionally, the registration request message may include one or more fields that indicate services that the WTRU 334 may use, and/or that indicate priorities associated with the services. For example, the registration request may indicate that the WTRU 334 may use a Voice over IP (VoIP) service, and indicate that the VoIP service has a high priority. The registration request may further indicate that the WTRU 334 may use a P2P file transfer service, and that P2P file transfer service has a low priority.

Alternatively or additionally, the registration request message may also indicate QoS requirements of the WTRU 334. The QoS requirements may indicate, for example, a required data rate, a required data loss rate, a required delay, a required jitter, and/or other required QoS parameters. The QoS requirements of the WTRU 334 may be included in, for example, a QoSReq field in the registration request message.

Alternatively or additionally, the registration request message may include one or more fields that indicate whether the WTRU is re-registering with the same service requirements as described in a previous registration, whether the WTRU is re-registering with different service requirements from those described in a previous registration, and/or whether the WTRU is registering with the network management node 302 for the first time. This information may be included, for example, in a RequestCode field in the registration request message.

Alternatively or additionally, the registration request may include a field that indicates that the WTRU 334 is requesting authentication for all of the radio access technologies that are supported by the network management node 302.

The MIH server unit 328, in conjunction with the AAA unit 226, may determine whether the WTRU 334 should be authenticated (step 358). This may include one or more messages being transmitted between the MIH server unit 328 and the AAA unit 226. If the registration request included a field that indicated that the WTRU 334 was requesting authentication for all of the radio access technologies supported by the WTRU, the MIH server unit 328 and/or the AAA unit 226 may authenticate the WTRU for all of the radio access technologies and/or radio access networks available in the network managed by the network management node 302.

In a circumstance where the WTRU 334 is a cellular-capable WTRU and where the network management unit has a femtocell base station (not depicted) in its managed network or includes a femtocell radio access unit, the network management node may additionally register the WTRU 334 with a cellular core network (not depicted). This may be performed by, for example, a CWM unit in the network management node 302. This may include the CWM unit sending authentication and/or registration information of the WTRU 334 to the cellular core network via the femtocell base station or the femtocell radio access unit.

Following the registration/authentication, the MIH server unit 328 may send a registration response message to the WTRU 334 (step 360). The registration response message may be, for example, an MIH_Register.response message. The registration response message may include one or more fields indicating whether the registration is successful or not. For example, the registration response message may indicate that the registration request is denied. The registration response message may indicate that the WTRU is registered, but that service to the WTRU 334 may be pending because the network management node 302 does not currently have resources in its managed networks to provide services to the WTRU 334. Alternatively, the registration response message may indicate that the registration is successful. Information related to the result of the registration may included in, for example, a RegistrationResult field. Alternatively or additionally, the registration response message may include one or more fields that indicate why a registration was not successful. This information may be included in, for example, a Reason Code field in the registration result message. Alternatively or additionally, the registration response message may include one or more fields that indicate a time interval by which the WTRU 334 must re-register with the network management node 302. This information may be included, for example, in a ReRegistrationInterval field in the registration response message.

Referring to FIG. 3B, the MIH server unit 328 and/or the spectrum management unit 324 may then determine whether the QoS requirements of the WTRU can be supported by the current radio link between the WTRU 334 and the radio access unit 320 (step 362). This may be based on, for example, QoS data from the radio access unit 320 managed by the spectrum management unit 324, and/or on the QoS requirements indicated by the WTRU 334 in the registration request message. If the MIH server unit 328 and/or the spectrum management unit 324 determine that the current radio link between the WTRU 334 and the radio access unit 320 does not support the QoS of the WTRU, they may determine that the WTRU 334 should be handed over to a different radio access unit (not depicted) in the network management node 302 or to a different base station (not depicted) in the network managed by the network management node 302. The WTRU 334 may then be handed over to the different radio access unit or base station. The WTRU 334 and network management node 302 may then perform the method of FIG. 3A-3B and/or a different registration method, using the different radio access node or base station. Alternatively, if the WTRU 334 has already has a current active radio link that provides adequate QoS, the MIH server unit 328 and/or spectrum management unit 324 may determine that the WTRU 334 should stay on its current link and not be handed over to a different radio access network.

If it is determined that the radio access unit 320 does not support the QoS requirements of the WTRU 334 (step 362), the WTRU 334 may be handed over to a different radio access network. If it is determined that the radio access unit 320 supports the QoS requirements of the WTRU, the MIH server unit 328 may send a measurement reporting configuration message to the WTRU 334 (step 364). The measurement reporting configuration message may be, for example, an MIH_Link_Configure_Thresholds.request. The measurement reporting configuration message may indicate that the WTRU should configure thresholds for radio link measurement reporting. The measurement reporting configuration message may indicate, for example, that the WTRU should send a measurement report when a particular QoS parameter falls below or exceeds a threshold value. Alternatively or additionally, the measurement reporting configuration message may indicate that the WTRU 334 should establish periodic link measurement reporting. The WTRU 334 may configure link measurement reporting thresholds and/or periodic reporting as indicated in the measurement reporting configuration message. The WTRU may then send a measurement reporting configuration response message (step 366). The measurement reporting configuration response message may be, for example, an MIH_Link_Configure_Thresholds.response message.

The MIH server unit 328 may send a link event subscription message to the WTRU 334 (step 368). The link event subscription request message may indicate types of link events for which the MIH server unit 328 should be notified by the WTRU 334. The WTRU 334 may generate a link event, for example, when it detects that a radio link is up, that a radio link is up, that a radio link is going down. A link event may also indicate current QoS parameters on a radio link. The link event subscription request message may be, for example, an MIH_Event_Subscribe.request. The WTRU 334 may configure event reporting as indicated in the link event subscription request message. The WTRU 334 may then send a link event subscription response message to the MIH server unit 328 (step 370). The link event subscription response message may be, for example, an MIH_Event_Subscribe.response message.

The WTRU 334, the MIH server unit 328, and the spectrum management unit 324 may then perform periodic registration updates and service modifications (step 372). Periodic registration updates may include the periodic exchange of registration request and registration response messages, such as the exchange described above with reference to FIG. 3A (step 356, step 358, step 360, step 362) and/or other message. Services used at the WTRU 334 and/or QoS requirements of the WTRU 334 may change over time, and the changes may be reflected in the registration request messages.

Alternatively or additionally, the periodic registration updates (step 372) may include the MIH server unit 328 periodically sending a query to the WTRU 334 regarding its registration status. The WTRU 334 may send a response to the query that includes information such as the information included in a registration request message as described above. The query may be, for example, an MIH_Net_Registration_Query.request message. The response may be, for example, an MIH_Net_Registration_Query.response message.

Depending upon the information obtained in a period registration update, the WTRU 334, MIH server unit 328, and/or spectrum management unit 324 may take a number of different actions (not depicted). For example, a registration update may indicate that the WTRU 334 should be de-registered from the network management node 302 or that the WTRU 334 should switch radio access networks. Alternatively, if the MIH server unit 328 does not receive expected information from the WTRU 334 during the periodic registration update, the MIH server unit 328 may determine that the WTRU 334 is no longer in communication with the network management node 302, and that resources allocated for the WTRU 334 should be released. The WTRU 334, MIH server unit 328, and/or spectrum management unit 324 may then perform actions based on the information obtained in the periodic registration update.

The method of FIGS. 3A-3B may be used in any number of contexts. It may be used, for example, when a WTRU first powers on, and/or when a WTRU moves from a WAN or any other network not within a managed network into a radio access network in the managed network. A WTRU that is a multimode WTRU may be connected to a WAN, and may perform the method of FIGS. 3A-3B to register with the network management node 302 without breaking the radio link to the WAN. For example, the WTRU 334 of FIGS. 3A-3B may be connected to a macrocell, and the radio access unit 320 of the network management node may be a WLAN radio access unit. In this example, the WTRU 334 may preserve the connection to the macrocell throughout and/or subsequent to performance of the method of FIGS. 3A-3B.

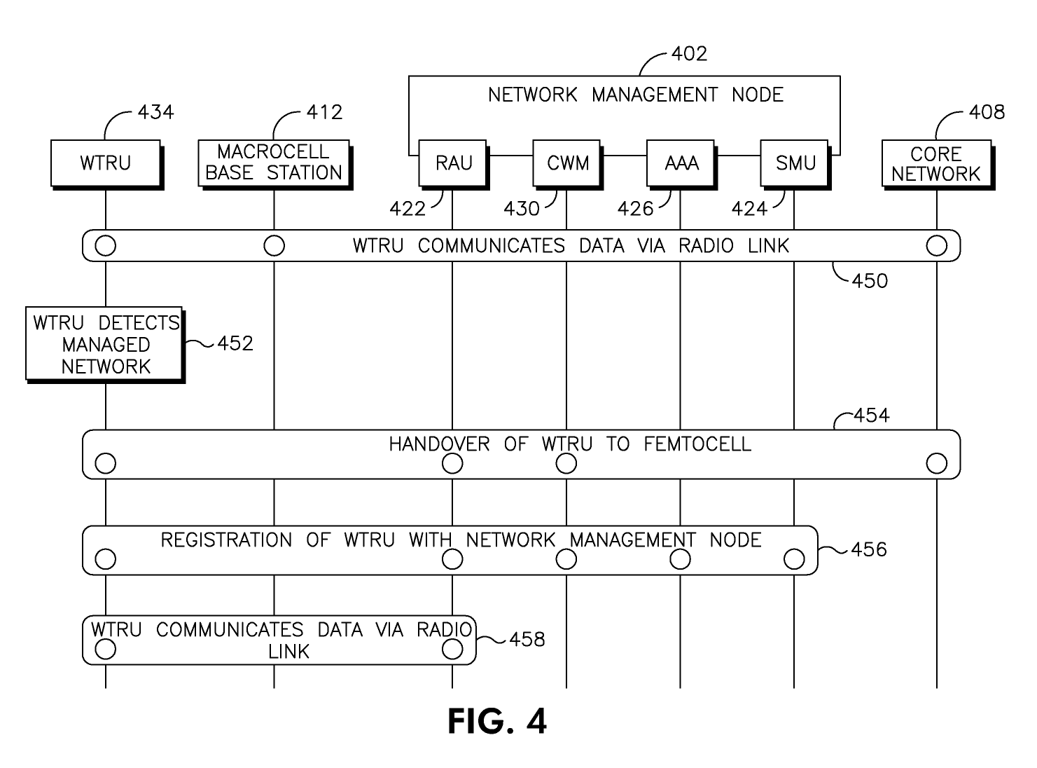

FIG. 4 shows an example method for the registration of a WTRU 434 with a network management node 402, wherein the WTRU 434 moves from a macrocell to a femtocell managed by a network management node 402. In addition to the WTRU 434 and the network management node 402, FIG. 4 shows a macrocell base station 412, and a core network 408. The network management node 402 may include a femtocell unit (RAU) 422, a AAA unit 426, a cellular WTRU management unit (CWM) 430, and a spectrum management unit (SMU) 424.

The method of FIG. 4 may begin with the WTRU 434 communicating data on a radio link with the macrocell base station (step 450). This may include, for example, the WTRU 434 receiving services from the core network 408 via the radio link. The WTRU 434 may enter an area managed by the network management node 402, and may detect the femtocell provided by the femtocell unit 422 in the network management node 402 (step 452). The WTRU 434 may make a determination, based on the detection of the femtocell, to perform a handover to the femtocell.

The WTRU 434 and the femtocell unit 422 may then perform a handover of the WTRU to the femtocell (step 454). The macrocell base station 412 and the core network 408 may also be involved in the handover. Performing the handover may include the WTRU and the femtocell unit 422 establishing a radio link.

The femtocell unit 422, cellular WTRU management unit 430, and/or AAA unit 426 may perform a registration of the WTRU 434 with the network management node 402 (step 456). This may include the femtocell unit 422 communicating authentication and/or registration data to the cellular WTRU management unit 430. The authentication and/or registration data may be data used by the WTRU 434 to authenticate and/or register with the core network 408. The cellular WTRU management unit 430 may translate the cellular authentication/registration data to a format used by the AAA unit 426. The femtocell unit 422 may have received the cellular authentication/registration data from the WTRU 434 during the handover to the femtocell (step 454), or at a different time preceding or following the handover to the femtocell. Alternatively or additionally, the spectrum management unit 424 may participate in the registration procedure.

The cellular WTRU management unit 430 may then determine, based on the authentication and/or registration data, whether the WTRU 434 is permitted to access networks managed by the network management node 402. The cellular WTRU management unit 430 may make this determination in conjunction with the AAA unit 426. For example, the cellular WTRU management unit 430 may communicate translated authentication/registration data to the AAA unit 426, and receive a response from the AAA unit 426 as to whether the WTRU 434 is has been successfully authenticated/registered. If the WTRU 434 is not permitted to access the network managed by the network management node 402, then the network management node 402 may treat the WTRU 434 as a “guest” in its network. A “guest” WTRU in the network may be permitted for example, to have access to radio access networks for emergency call purposes, to have only limited-bandwidth access, and/or to have access to spectrum only if spectrum is otherwise entirely unused. If the WTRU 434 is permitted to access the network managed by the network management node 402, the WTRU may communicate data on the radio link with the femtocell unit 422 (step 458).

In various implementations, the handover of the WTRU 434 to the femtocell (step 454) may be initiated in different ways. The macrocell base station 412 (and/or one or more other network nodes in communication with the macrocell base station, such as a base station controller (BSC), radio network controller (RNC), Mobility Management Entity (MME), or Serving Gateway (S-GW)), may take measurement reports from the WTRU 434 into account when determining whether the WTRU 434 should perform a handover to the femtocell. To initiate a handover to the femtocell, the WTRU 434 may send a measurement report to the macrocell base station 412 that indicate that QoS on the macrocell provided by the macrocell base station 412 is lower than it actually is. The measurement report may be processed by the macrocell base station 412 (and/or one or more other network nodes such as the BSC, RNC, MME, or S-GW), and a determination may be made at one or more of the network nodes, based on the measurement report, that the WTRU 434 should be handed over to the femtocell. Alternatively or additionally, the measurement report may indicate that QoS on the femtocell provided by the femtocell unit 422 is higher than it actually is. After the determination is made that the WTRU 434 should be handed over to the femtocell, the macrocell base station 412 may send a handover command to the WTRU 434, indicating that the WTRU 434 should handover to the femtocell. The WTRU 434 may then perform the handover (step 454) in response to the handover command.

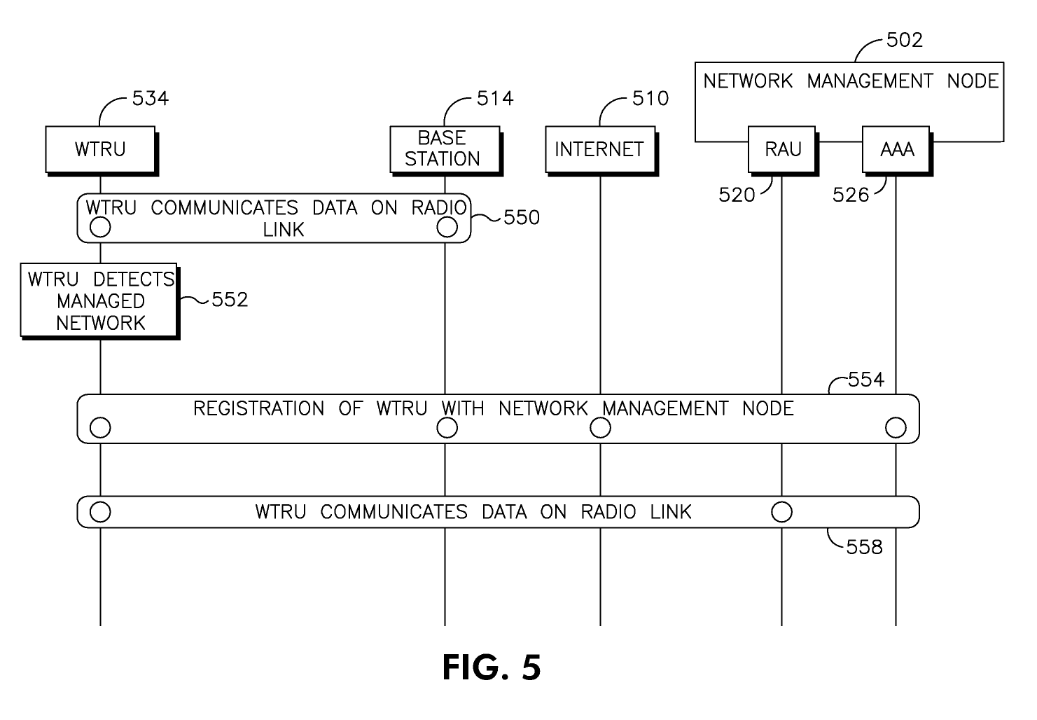

FIG. 5 shows an example method for the registration of a WTRU 534 with a network management 502 node via the Internet. In addition to the WTRU 534 and the network management node 502, FIG. 5 a base station 506 and the Internet 510. The network management node 502 may a radio access unit (RAU) 520 and a AAA unit 526. The base station 506 may not be within the managed network of the network management node 502. The base station 506 may have a link to the Internet 510, and the WTRU 534 may communicate data to/from the Internet 510 via the base station 506. The network management node 502 may also have a link to the Internet 510, and may communicate data to/from the Internet 510.

The method of FIG. 5 may begin with the WTRU 534 communicating data on a radio link with the base station 506 (step 550). The WTRU 534 may enter an area managed by the network management node 502, and may detect the radio access network provided by the radio access unit 520 in the network management node 502 (step 552). The WTRU 534 may make a determination, based on the detection of the radio access network, to register with the network management node 502.

To register with the network management node (step 554), the WTRU 534 may send one or more registration request messages to the network management node 502 via the base station and the Internet. The AAA unit 526 may make a determination, based on the registration request messages, as to whether the WTRU 534 is permitted to authenticate to the network management node 502. The AAA unit 526 may make this determination in conjunction with one or other units in the network management node 502, such as an MIH server unit (not depicted), a CWM (not depicted), and/or a spectrum management unit (not depicted). The registration of the WTRU (step 554) may additionally include the network management node 502 sending one or more registration response messages to the WTRU 534 via the Internet and the base station 514.

On a condition that the WTRU 534 is registered with the network management node 502, the WTRU may access a radio access network provided by the radio access unit 520 and communicate data on a radio link with the radio access network (step 558).

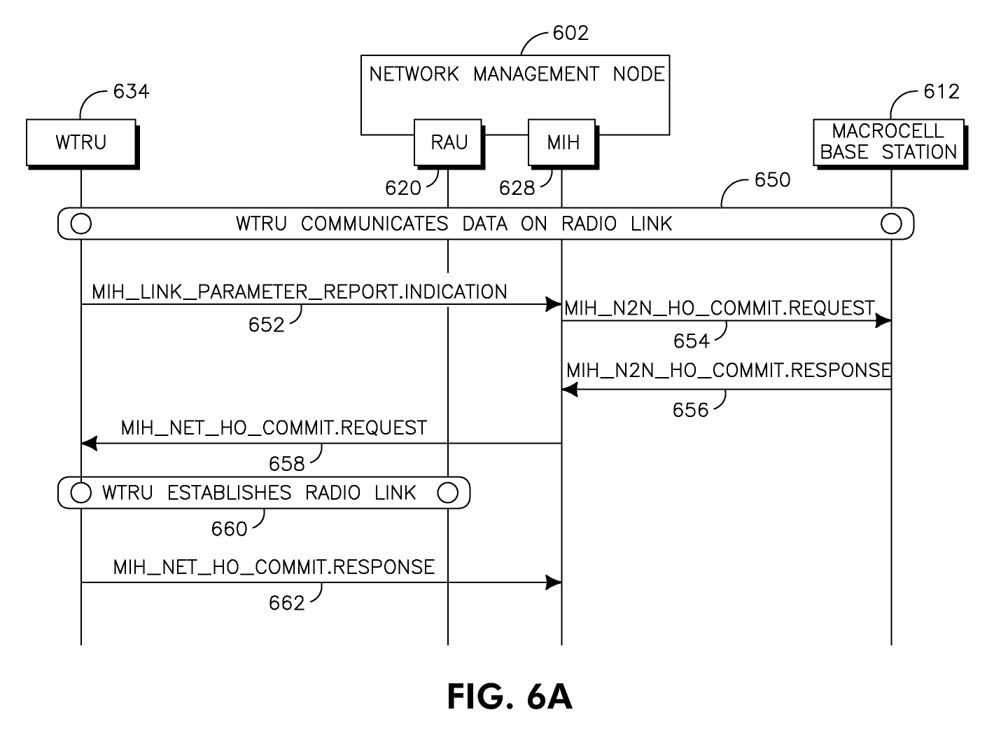

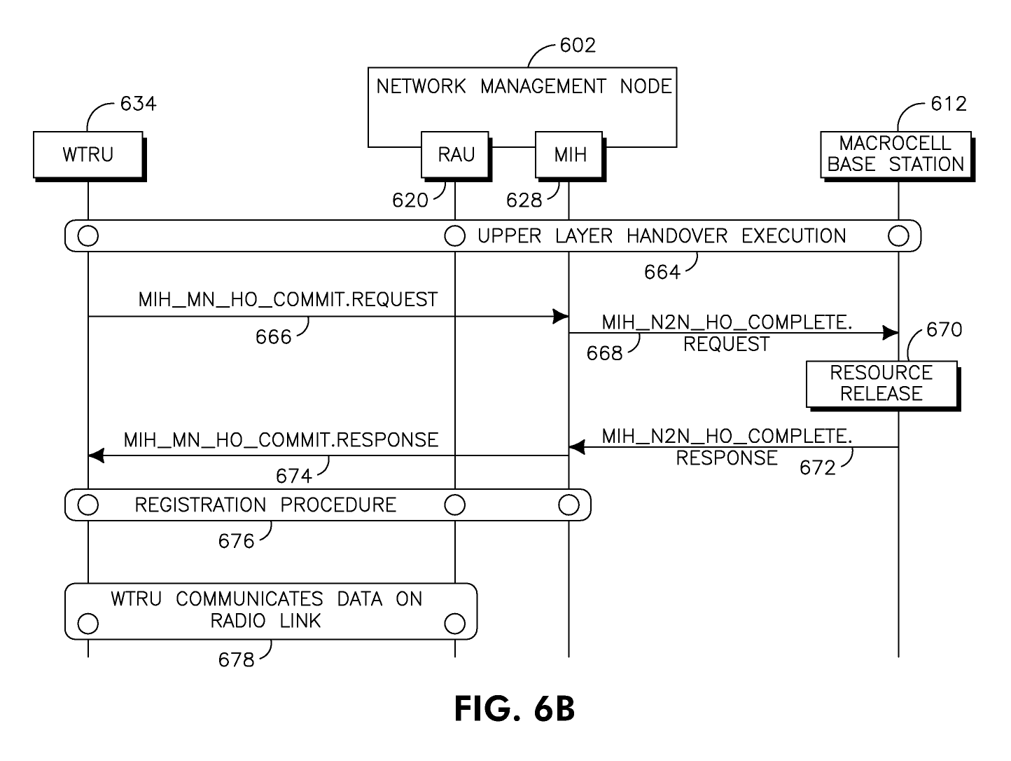

FIGS. 6A-6B show an example method for the handover of a WTRU 634 from a macrocell to a radio access network within the management network of a network management node 602. In addition to the WTRU 634 and the network management node 602, FIGS. 6A-6B show a macrocell base station 612. The network management node 602 may include a radio access unit (RAU) 620 and an MIH server unit 628. Prior to the method of FIG. 6A-6B, the WTRU 634 may have registered with the network management node 602. The registration may have been performed according the method of FIGS. 3A-3B, FIG. 4, and/or FIG. 5 (or any combination thereof), or according to a different registration procedure.

The method of FIGS. 6A-6B may begin as shown in FIG. 6A with the WTRU 634 communicating data on a radio link to the macrocell base station 612 (step 650). The WTRU 634 may send a measurement report message to the network management node 602 (step 652). The measurement report message may be sent by the WTRU 634 according to a measurement reporting configuration established during a registration with the network management node 602. The measurement report message may be, for example, an MIH_Link_Parameter_Report.indication. The network management node 602 may determine, based on the MIH_Link_Paramter_Report.indication, whether the WTRU 634 should be handed over from the macrocell to the radio access unit 620. This determination may also be based on service requirements of the WTRU 634. The MIH server unit 628 and/or a spectrum management unit (not depicted) in the network management node 602 may make the determination as to whether the WTRU 634 should be handed over.

If the network management node 602 makes a determination that the WTRU 634 should be handed over to the radio access unit 620, the network management node 602 may send an MIH_N2N_HO_Commit.request message to an MIH entity (not depicted) operating in the network of which the macrocell base station 612 is a part (step 654). If the MIH entity allows the WTRU 634 to be handed over, it sends an MIH_N2N_HO_Commit.response message to the network management node 602 (step 656). Based on the MIH_N2N_HO_Commit.response message, the MIH server unit 628 may initiate the handover by sending an MIH_Net_HO_Commit.request message to the WTRU 634 (step 658).

In response to the MIH_Net_HO_Commit.request message, the WTRU 634 may establish a radio link to the radio access unit 620 (step 660). If the radio link is successfully established, the WTRU 634 may send an MIH_Net_HO_Commit.response message to the network management node 602 (step 662).

Referring to FIG. 6B, the WTRU 634 may then perform an upper layer handover (step 664). Upper layer handover may include the transition of ongoing upper layer session such that the sessions are not interrupted. The radio access unit 620 and/or the macrocell base station 612 may participate in the upper layer handover. Following the upper layer handover, the WTRU 634 may close its radio link to the macrocell base station 612.

The WTRU 634 may report the completion of the handover by sending an MIH_MN_HO_Complete.request message to the network management node 602 (step 666). In response to the MIH_MN_HO_Complete.request message, the MIH server unit 628 may send an MIH_N2N_HO_Complete.request message to the macrocell base station 612. The macrocell base station 612 may then release resources reserved for the WTRU 634 (step 670). The macrocell base station 612 may then notify the network management node 602 that the resources are released by sending an MIH_N2N_HO_Complete.response message to the network management node 602 (step 672). In response to the MIH_N2N_HO_Complete.response message, the MIH server unit 628 may send an MIH_MN_HO_Complete.response message to the WTRU 634.

The WTRU 834 may then perform a registration procedure with the network management node (step 676). The registration may be performed according the method of FIGS. 3A-3B, FIG. 4, and/or FIG. 5 (or any combination thereof), or according to a different registration procedure. The radio access unit 620 and/or the MIH server unit 628 may participate in the registration procedure. Following a successful registration procedure, the WTRU may communicate data on a radio link with radio access unit 620 (step 678).

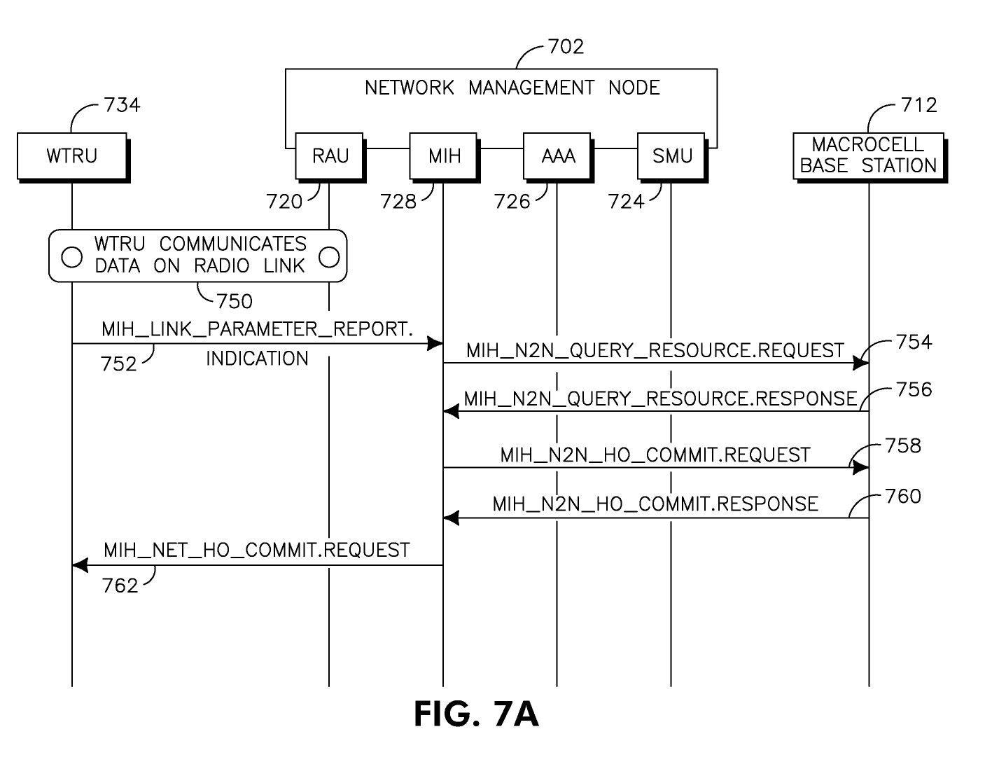

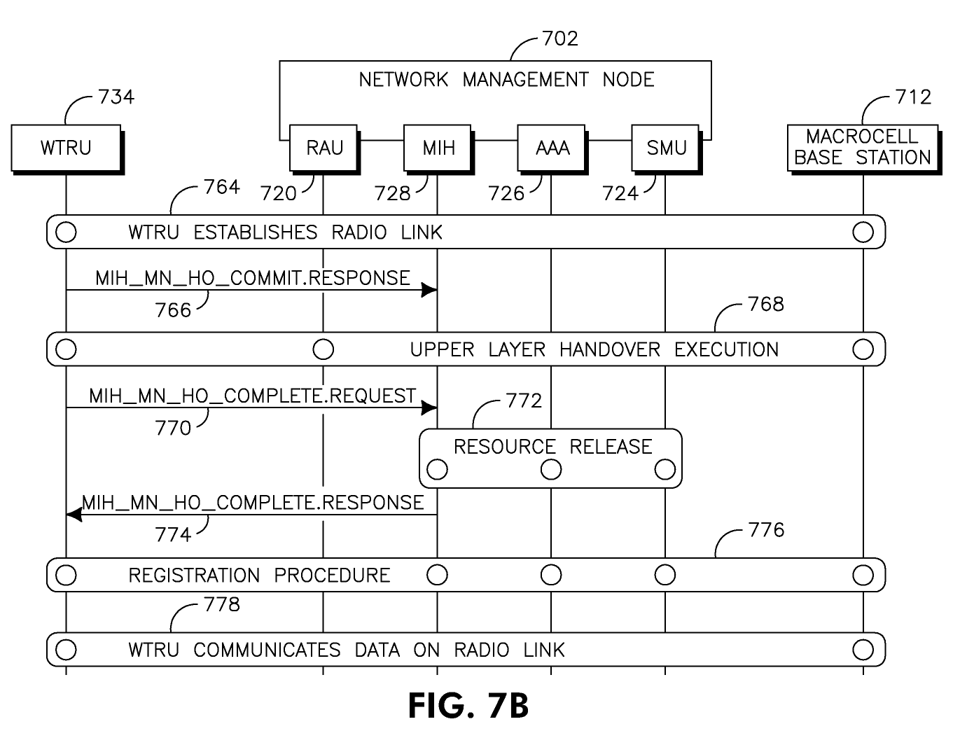

FIGS. 7A-7B show an example method for the handover of a WTRU 734 from a radio access network within a managed network to a macrocell. In addition to the WTRU 734, FIGS. 7A-7B a macrocell base station 712 and a network management node 702. The network management node 702 may include a radio access unit (RAU) 720, an MIH server unit 728, a AAA unit 726, and a spectrum management unit (SMU) 724. Prior to the method of FIG. 7A-7B, the WTRU 734 may have registered with the network management node 702. The registration may have been performed according the method of FIGS. 3A-3B, FIG. 4, and/or FIG. 5 (or any combination thereof), or according to a different registration procedure.

The method of FIGS. 7A-7B may begin as shown in FIG. 7A with the WTRU 734 communicating data on a radio link to the radio access unit 720 (step 750). The WTRU 734 may send a measurement report message to the network management node 702 (step 752). The measurement report message may be sent by the WTRU 734 according to a measurement reporting configuration established during a registration with the network management node 702. The measurement report message may be, for example, an MIH_Link_Parameter_Report.indication. The network management node 702 may determine, based on the MIH_Link_Paramter_Report.indication, whether the WTRU 734 should be handed over from the radio access unit 720 to the macrocell provided by the macrocell base station 712. This determination may also be based on service requirements of the WTRU 734. The MIH server unit 728 and/or the spectrum management unit 724 may make the determination as to whether the WTRU 734 should be handed over.

If the network management node 702 makes a determination that the WTRU 734 should be handed over to the radio access unit 720, the network management node may send a resource query message to the macrocell base station (step 754). The resource query message may indicate a query as to whether the recipient network has the resources available for a handover. The resource query message may be, for example, an MIH_N2N_HO_Query_Resource.request message. The macrocell base station 712 may send a response message (step 756). The response message may be, for example, an MIH_N2N_Query_Resources.response message. If the macrocell network does not have sufficient resources to accept the handover, this may be reflected in the response message. In such an instance, the network management node 702 may make a determination, based on the response message, to not handover the WTRU 734. If the response message indicates that the macrocell network has sufficient resources to accept the handover, this may be reflected in the response message.

The network management node 702 may send a handover commitment message to the macrocell base station (step 758). The handover commitment message may be, for example, an MIH_N2N_HO_Commit.request message. In response to the handover commitment message, the macrocell base station 712 may reserve resources for the WTRU 734. When the macrocell base station 712 is ready to accept the handover, the macrocell base station 712 may send a handover commitment response message to the network management node 702 (step 760). The handover commitment response message may be, for example, an MIH_N2N_HO_Commit.response message.

In response to the handover commitment response message, the network management node 702 may send a handover commitment message to the WTRU 734, indicating that the WTRU 734 should handover to the macrocell base station 712 (step 762). The handover commitment message may be, for example, an MIH_Net_HO_Commit.request message.

Referring to FIG. 7B, the WTRU 734 may establish a radio link with the macrocell base station 712 (step 764). The WTRU may establish the radio link with the macrocell base station in response to the handover commitment message. The WTRU 734 may then send an MIH_MN_HO_Commit.response message to the network management node 702 (step 766).

The WTRU 734 may then perform an upper layer handover (step 768). Upper layer handover may include the transition of ongoing upper layer session such that the sessions are not interrupted. The radio access unit 720 and/or the macrocell base station 712 may participate in the upper layer handover.

Upon completion of the upper layer handover, the WTRU 734 may send an MIH_MN_HO_Complete.request message to the network management node 702 (step 770). In response to the MIH_MN_HO_Complete.request message, the network management node 702 may release resources related to the WTRU 734 (step 772). This may include, for example, the AAA unit 726 and/or the spectrum management unit 724 modifying and/or deleting records related to the WTRU 734. The network management node 702 may then send an MIH_MN_HO_Complete.response message to the WTRU (step 734).

The WTRU 734 may then perform a registration procedure with the network management node 702 (step 776). The registration may be performed according the method of FIGS. 3A-3B, FIG. 4, and/or FIG. 5 (or any combination thereof), or according to a different registration procedure. The MIH server unit 728, AAA unit 726, and/or spectrum management unit 724 may participate in the registration procedure. Following a successful registration procedure, the WTRU may communicate data on a radio link with the macrocell base station 712 (step 778).

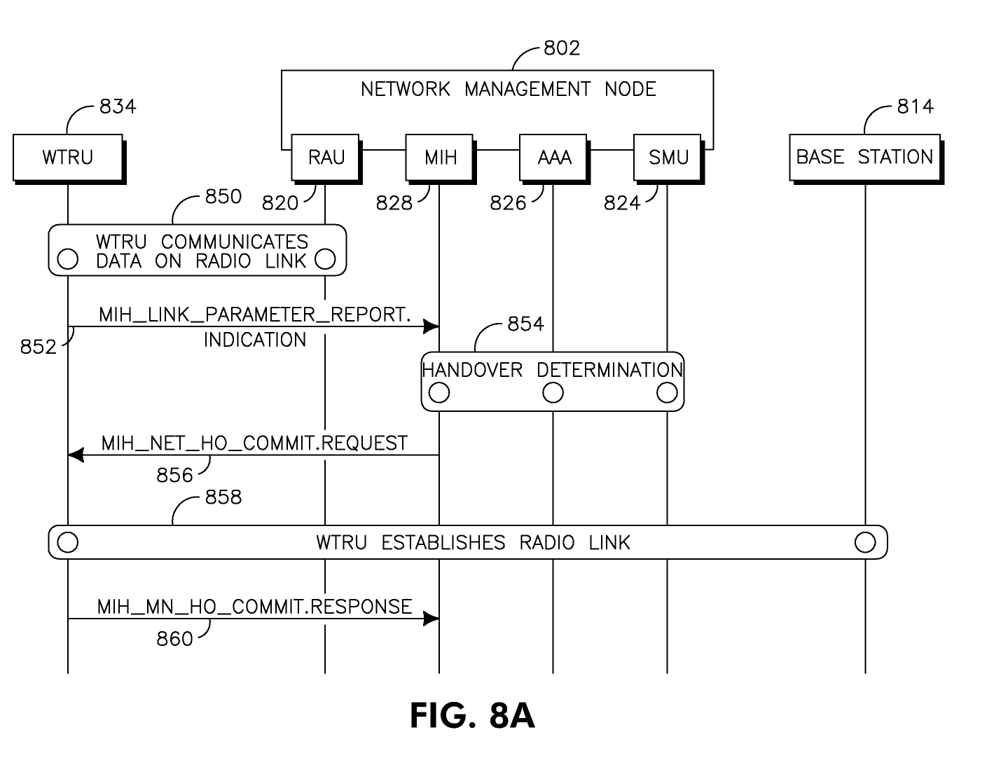

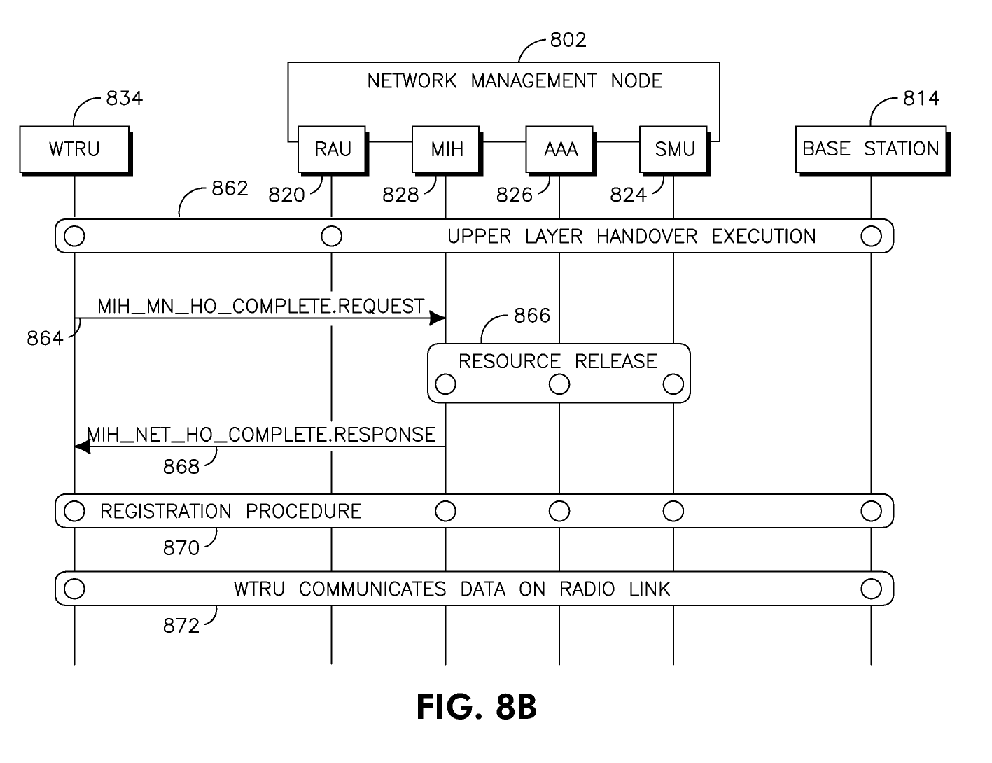

FIGS. 8A-8B show an example method for handover of a WTRU 834 between radio access networks in a managed network. In addition to the WTRU 834, FIGS. 8A-8B show a base station 812 and a network management node 802. The network management node 802 may include a radio access unit (RAU) 820, an MIH server unit 828, a AAA unit 826, and a spectrum management unit (SMU) 824. The base station 814 may be a WLAN base station, a femtocell base station, or any other type of base station. The base station 814 may be within the managed network of the network management node 802. Prior to the method of FIG. 8A-8B, the WTRU 834 may have registered with the network management node 802. The registration may have been performed according the method of FIGS. 3A-3B, FIG. 4, and/or FIG. 5 (or any combination thereof), or according to a different registration procedure.

The method of FIGS. 8A-8B may begin as shown in FIG. 8A with the WTRU 834 communicating data on a radio link to the radio access unit 820 (step 850). The WTRU 834 may send a measurement report message to the network management node 802 (step 852). The measurement report message may be sent by the WTRU 834 according to a measurement reporting configuration established during a registration with the network management node 802. The measurement report message may be, for example, an MIH_Link_Parameter_Report.indication.

The network management node 802 may determine, based on the measurement report message, whether the WTRU 834 should be handed over from the radio access unit 820 to the base station provided by the base station 812 (step 854). This determination may also be based on service requirements of the WTRU 834. This determination may also include a selection of a target access network. This determination (step 854) may be made by the MIH server unit 828, the AAA unit 826, and/or the spectrum management unit 824.

If the network management node 802 makes a determination that the WTRU 834 should be handed over to the radio access unit 820, the network management node 802 may send a handover commitment request message to the WTRU 834 (step 856). The handover commitment message may be, for example, an MIH_Net HO_Commit.request.

In response to the handover commitment request message, the WTRU 834 may establish a radio link with the base station 814 (step 858). Upon successful establishment of the radio link with the base station 814, the WTRU 834 may send a handover commitment response message to the network management node 802 (step 860). The handover commitment response message may be, for example, an MIH_MN_HO_Commit.response message.

Referring to FIG. 8B, the WTRU 834 may then perform an upper layer handover (step 862). Upper layer handover may include the transition of ongoing upper layer session such that the sessions are not interrupted. The radio access unit 820 and/or the base station 814 may participate in the upper layer handover.

Upon completion of the upper layer handover, the WTRU 834 may send an MIH_MN_HO_Complete.request message to the network management node 802 (step 864). In response to the MIH_MN_HO_Complete.request message, the network management node 802 may release resources related to the WTRU 834 (step 866). This may include, for example, the AAA unit 826 and/or the spectrum management unit 824 modifying and/or deleting records related to the WTRU 834. The network management node 802 may then send an MIH_MN_HO_Complete.response message to the WTRU (step 868).

The WTRU 834 may then perform a registration procedure with the network management node 802 (step 870). The registration may be performed according the method of FIGS. 3A-3B, FIG. 4, and/or FIG. 5 (or any combination thereof), or according to a different registration procedure. The MIH server unit 828, AAA unit 826, and/or spectrum management unit 824 may participate in the registration procedure. Following a successful registration procedure, the WTRU may communicate data on a radio link with the base station 814 (step 872).

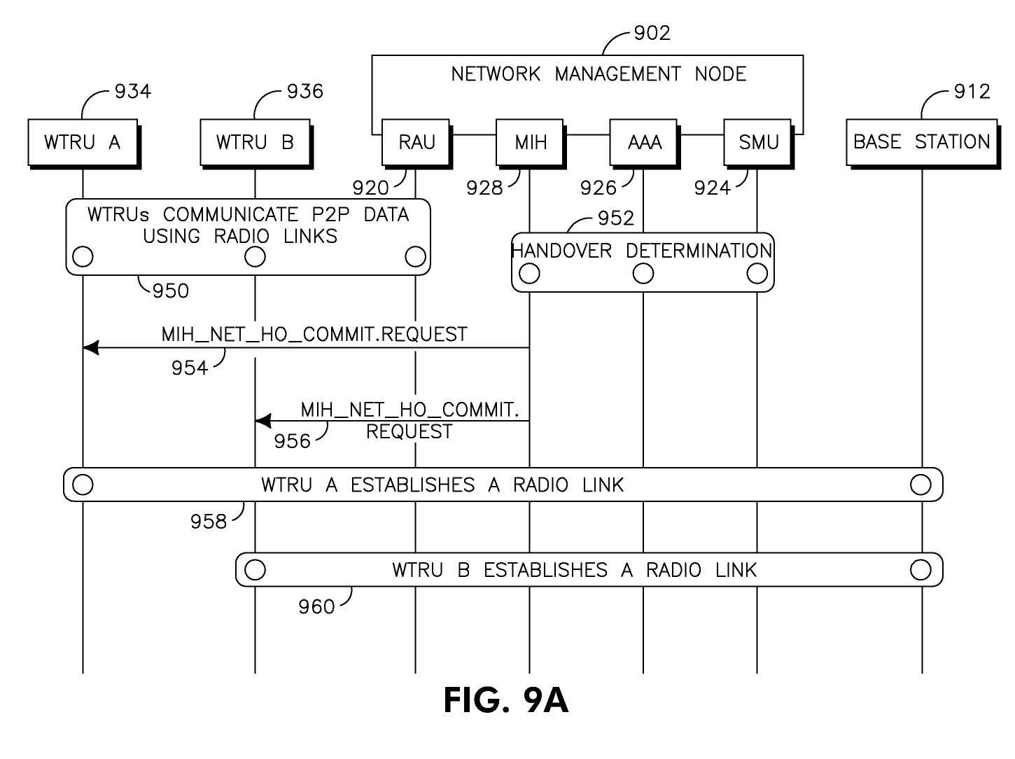

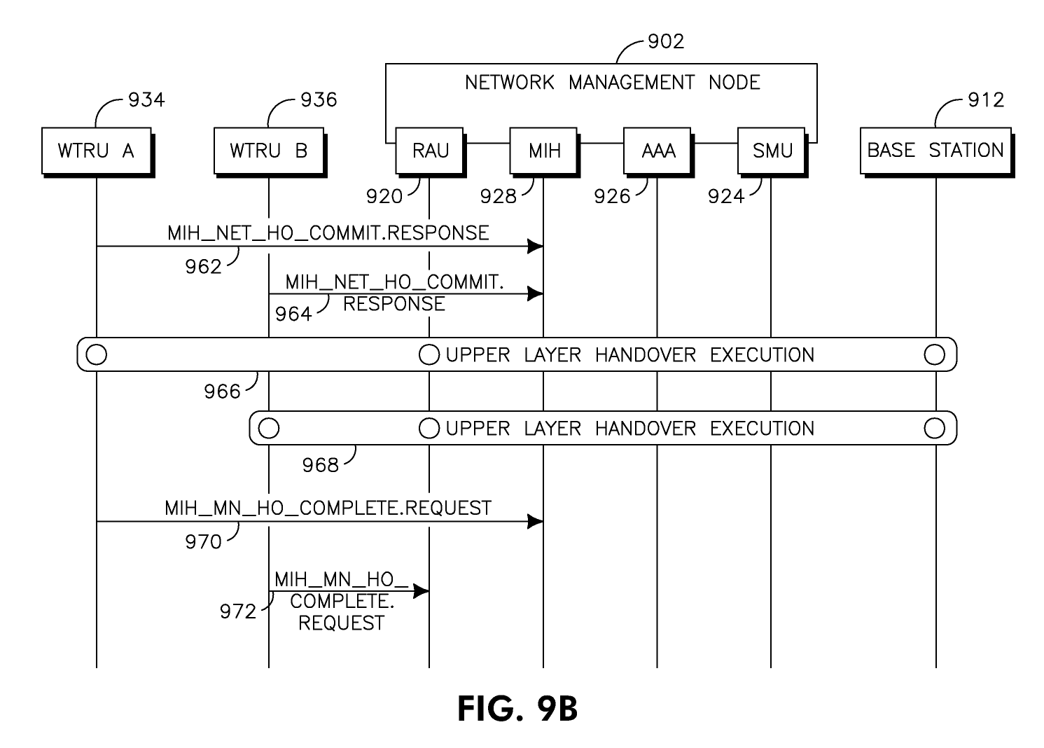

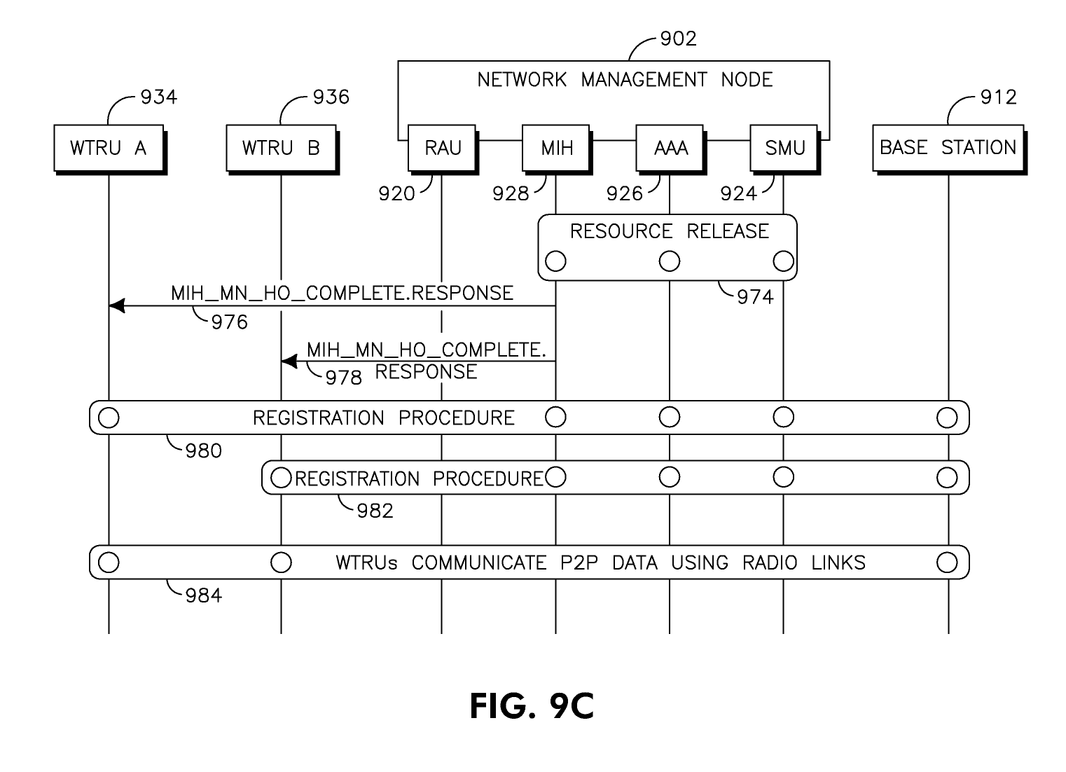

FIGS. 9A-9C show an example method for handover of WTRUs 934, 936 in a P2P group between radio access networks in a managed network. In addition to the WTRUs 834, 936, FIGS. 9A-9C show a base station 912 and a network management node 902. The network management node 902 may include a radio access unit (RAU) 920, an MIH server unit 928, a AAA unit 926, and a spectrum management unit (SMU) 924. The base station 912 may be a WLAN base station, a femtocell base station, or any other type of base station. The base station 912 may be within the managed network of the network management node 902. Prior to the method of FIG. 9A-9B, WTRU A 934 and WTRU B 936 may have registered with the network management node 902. The registrations may have been performed according the method of FIGS. 3A-3B, FIG. 4, and/or FIG. 5 (or any combination thereof), or according to different registration procedures. The base station 912 and the radio access unit 920 may operate using different radio access technologies.

The method of FIGS. 9A-9C may begin as shown in FIG. 9A with the WTRU A 934 and WTRU B 936 communicating data as a P2P group on a P2P application on radio links to the radio access unit 920 (step 950). A P2P group may include WTRUs (such as WTRU A 934 and WTRU B 936) that communicate without the need for central coordination. A P2P application may include, for example, an application layer overlay on top of the network layer, to perform indexing and peer discovery. Examples of P2P applications include file-sharing applications, streaming media applications, VoIP applications, and other applications.

The network management node 902 may make a determination that the P2P group should be handed over from the radio access network provided by the radio access unit 920 to a different radio access network (step 952). This determination may be based on the initiation of a new application by WTRU A 934 and/or WTRU B 936 that requires more or less network resources than previous applications. Alternatively or additionally, this determination may be based on crowding on the radio access network provided by the radio access unit 920, such that QoS of the P2P communications by WTRU A 934 and WTRU B 936 cannot be guaranteed. Alternatively or additionally, this determination may be based on one or more measurement report messages received from WTRU A 934 and/or WTRU B 936. The measurement report messages may include, for example, one or more MIH_Link_Parameter_Report.indication messages. The measurement report messages may be sent by WTRU A 934 and/or WTRU B 936 according to a measurement reporting configuration established during registration with the network management node 802. This determination (step 854) may also include a selection of a target access network. This determination may be made by the MIH server unit 928, the AAA unit 926, and/or the spectrum management unit 924.

If the network management node 902 makes a determination that the P2P group should be handed over, the network management node 902 may send handover commitment request messages to WTRU A 934 (step 954) and to WTRU B 936 (step 956). The handover commitment request messages may indicate a radio access network and/or a base station to which the WTRUs 934, 936 should handover. For example, the handover commitment message may identify the base station 912 and/or the radio access network provided by the base station 912. The handover commitment request messages may be, for example, an MIH_Net_HO_Commit.request messages. In response to the handover commitment request messages, WTRU A 934 and WTRU B 936 may establish radio links with the base station 912 (step 958, step 960).

Referring to FIG. 9B, WTRU A 934 and WTRU B 936 may send handover commitment response messages to the radio access unit 920 (step 962, step 964). The handover commitment response messages may be, for example, MIH_Net_HO_Commit.response messages. WTRU A 934 and WTRU B 936 may then perform upper layer handovers (step 966, step 968). An upper layer handover may include the transition of ongoing upper layer session such that the sessions are not interrupted. The radio access unit 920 and/or the base station 912 may participate in one or more of the upper layer handovers. WTRU A 934 and WTRU B 936 may then send handover complete request messages to the network management node 902 (step 970, step 972), to request completion of the handovers. The handover complete request messages may be, for example, MIH_MN_HO_Complete.request messages.

Referring to FIG. 9C, the network management node 902 may, in response to the handover complete request messages, release resources related to WTRU A 934 and WTRU B (step 974). This may include, for example, the AAA unit 926 and/or the spectrum management unit 924 modifying and/or deleting records related to WTRU A and WTRU B 934. The network management node 902 may then send handover complete response messages to WTRU A 934 and WTRU B 936 (step 976, step 978). The handover complete response messages may be, for example, MIH_MN_HO_Complete.response messages.

WTRU A 934 and WTRU B 936 may then perform registration procedures with the network management node 902 (step 980, step 982). The registration may be performed according the method of FIGS. 3A-3B, FIG. 4, and/or FIG. 5 (or any combination thereof), or according to a different registration procedure. The MIH server unit 928, AAA unit 926, and/or spectrum management unit 924 may participate in the registration procedure. Following successful registration procedures, the WTRU may communicate P2P data on radio links with the base station 912 (step 984).

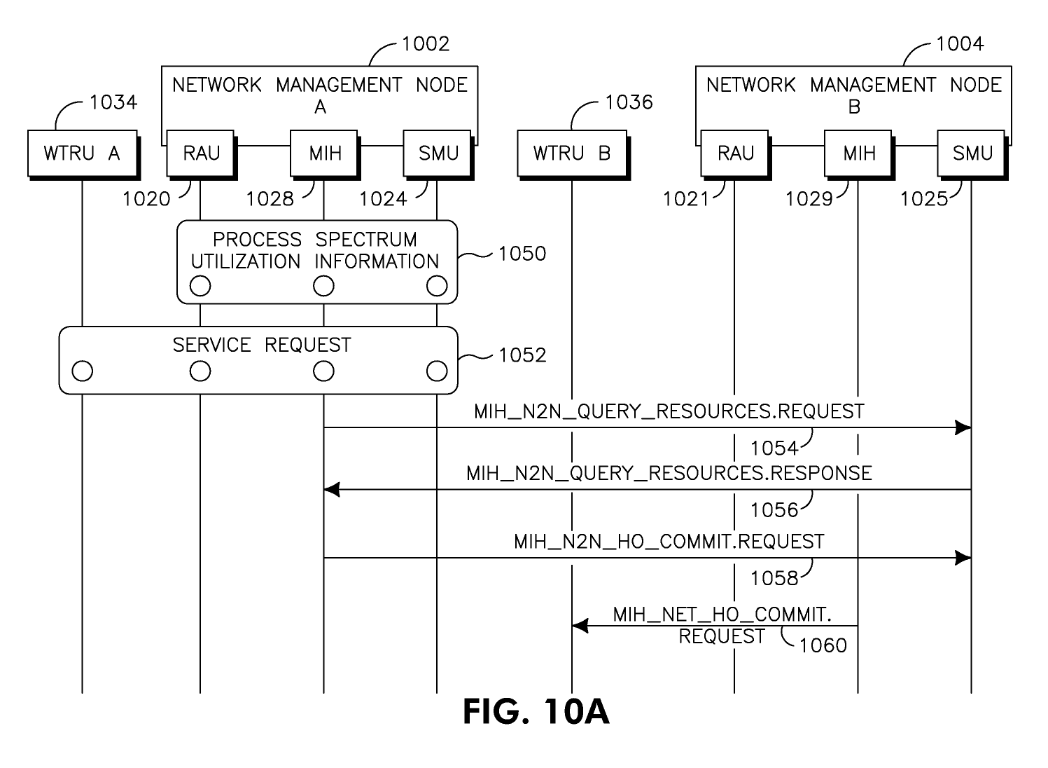

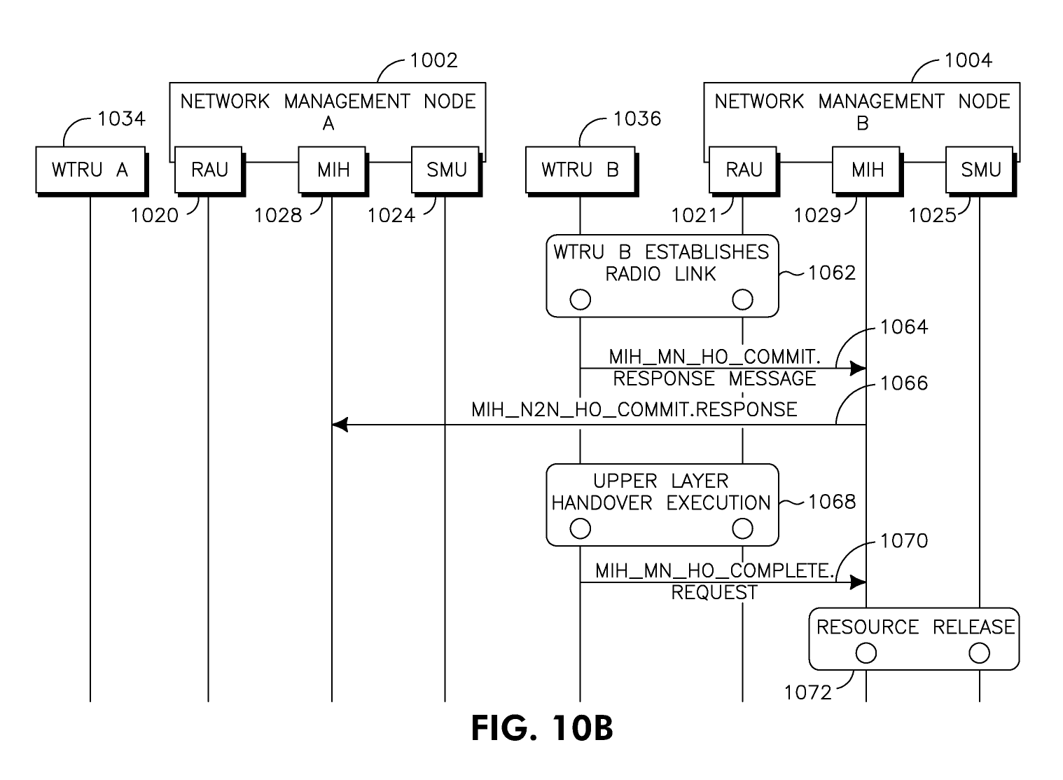

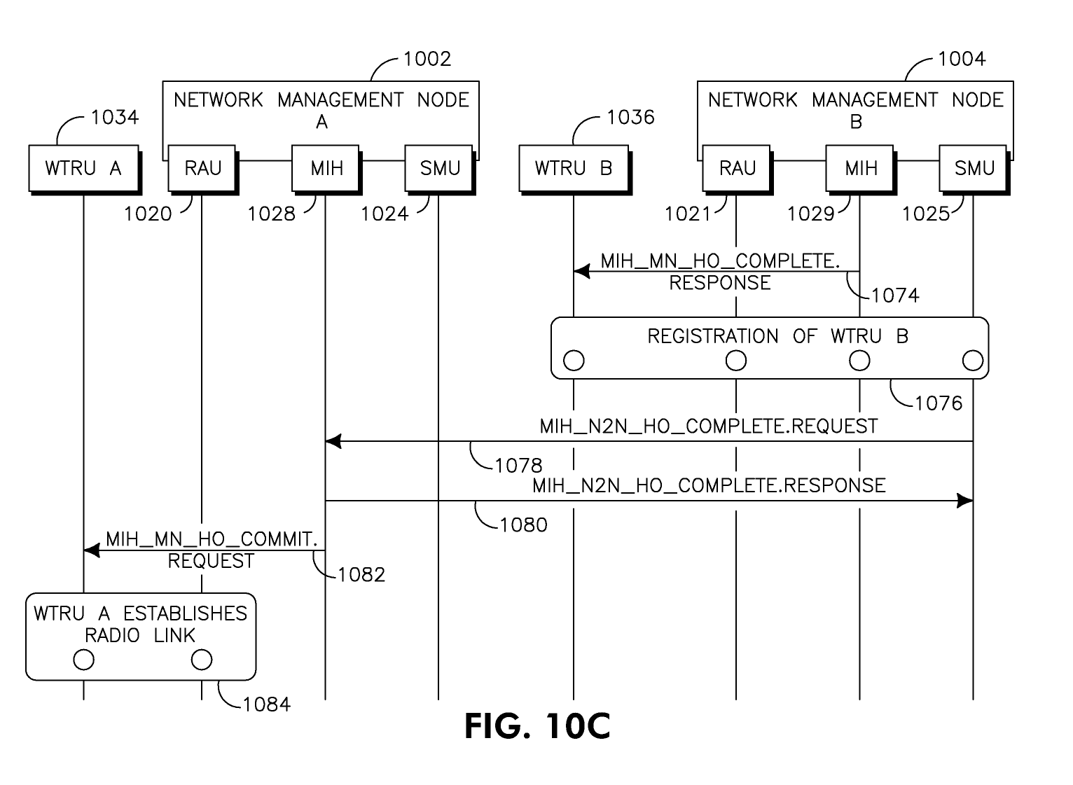

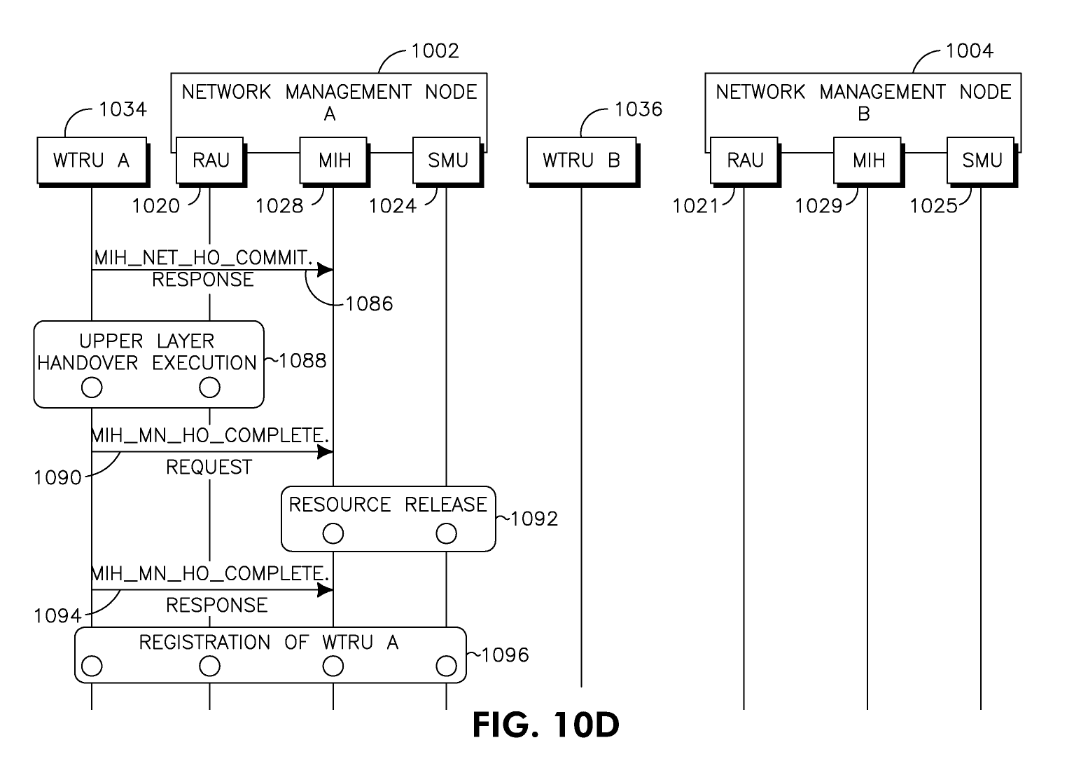

FIGS. 10A-10D show an example method for spectrum management performed by a pair of network management nodes 1002, 1004. In addition to Network Management Node A 1002 and Network Management Node B 1004, FIGS. 10A-10D show WTRU A 1034, WTRU B 1036. Network Management Node A 1002 may include a radio access unit (RAU) 1020, an MIH server unit 1028, and a spectrum management unit (SMU) 1025. Network Management Node B 1004 may include a radio access unit (RAU) 1021, an MIH server unit 1029, and a spectrum management unit (SMU) 1026.

Prior to the method of FIG. 10A-10B, WTRU A 1034 and/or WTRU B 1036 may be communicating with one or more base stations (not depicted). WTRU A 1034 may have registered with Network Management Node A 1002, and WTRU B 1036 may have registered with Network Management Node B 1004. The registrations may have been performed according the method of FIGS. 3A-3B, FIG. 4, and/or FIG. 5 (or any combination thereof), or according to different registration procedures. The base stations with which WTRU A and/or WTRU B communicate (not depicted) may operate using different radio access technologies from the access technologies used by the radio access units 1020, 1021 in Network Management Node A 1002 and/or Network Managemetn Node B 1004.

The method of FIGS. 10A-10D may begin as shown in FIG. 10A with Network Management Node A 1002 receiving and processing spectrum utilization information (step 1050). This may include, for example, receiving measurement report messages from WTRUs operating in any of the radio access networks managed by Network Management Node A 1002. The measurement report messages may include, for example, MIH_Link_Parameter_Report.indication messages.

WTRU A 1034 may request service on a radio access network in the network managed by Network Management Node A 1002 (step 1052). This may include, for example, sending a service request message to Network Management Node A 1002. In response to the request for service, Network Management Node A 1002 may determine whether radio resources are available in the networks managed by Network Management Node A 1002 to provide the service. This determination may be performed by the MIH server unit 228 and/or the spectrum management unit 224. This determination may be based on, for example, current QoS characteristics on the radio access networks managed by Network Management Node A 1002. Network Management Node A may determine QoS characteristics of its managed networks based on, for example, measurement report messages received as described above (step 1050). Network Management Node A 1002 may determine that current radio conditions do not support the service request. In such an instance, Network Management Node A 1002 may make a determination to negotiate with one or more other network management nodes (such as Network Management Node B 1004) to make radio resources (such as, for example, a frequency band) available so as satisfy the service request.

Network Management Node A 1002 may send a resources query message to Network Management Node B 1004 (step 1054). The resources query message may be, for example, an MIH_N2N_Query_Resources.request message. The resources query message may indicate a request for Network Management Node B 1004 make a frequency band available. Alternatively or additionally, the resources query message may request that Network Management Node B 1004 make a radio access network available. In response to the MIH_N2N_Query_Resources.request message, Network Management Node B 1004 may determine whether it is able to make radio resources available as indicated in the resources query message. For example, Network Management Node B 1004 may have data that indicates that WTRU B 1036 could be handed over to a different frequency band and/or radio access network, and that the handover would make radio resources available as requested in the resources query message. This determination may be performed by, for example, the MIH server unit 1029 and/or the spectrum management unit 1025 in Network Management Node B 1004. In some circumstances, a radio access network may operate only within a specific frequency band or bands. In such a circumstance, a resources query message that indicates a specific frequency band may be interpreted by Network Management Node B 1004 as a request for resources on a radio access network that operates within the specific frequency band. Alternatively or additionally, a resources query message request that indicates a request for resources on a specific radio access network may be interpreted by Network Management Node B 1004 a request for a frequency band that corresponds to the specific radio access network.

Network Management Node B 1004 may send a resources query response message to Network Management Node A 1002 (step 1056). The resources query response message may indicate that Network Management Node B 1004 is be able to make radio resources (such as, for example, a frequency band) available as indicated in the resources query message. The resources query response message may be, for example, an MIH_N2N_Query_Resources.response message. Although FIGS. 10A-10D show two network management nodes 1002, 1004, in various implementations, more than two network management nodes may be involved in the negotiation for radio resources. For example, Network Management Node A 1002 may send a number of resources query messages to different peer network management nodes, and receive a number of a resources query response messages in response.

If the resources query response message from Network Management Node B 1004 indicates that Network Management Node B 1004 is able to make radio resources available, Network Management Node A 1002 may send a resources commitment request message to Network Management Node B 1004 (step 1058). The resources commitment request message may be, for example, an MIH_N2N_HO_Commit.request message. The resources commitment request message may indicate a request that Network Management Node B make radio resources available as indicated in the resources query and/or resources query response messages. In a circumstance where Network Management Node A 1002 received multiple positive resources query response messages, Network Management Node A 1002 may select one of the senders of the positive resources query response messages, and send the resources commitment request message to the selected sender. This selection may be based on, for example, the load on the other network management nodes, a user configuration, and/or established trust relationships between Network Management Node A and the other network management nodes.

Network Management Node B 1004 may determine, in response to the resources commitment request message, to handover WTRU B 1036 to a different frequency band and/or radio access network. This determination may be performed by the MIH server unit 1029 and/or the spectrum management unit 1025. If Network Management Node B 1004 determines to perform the handover WTRU B, Network Management Node B 1004 may send a handover commitment request message to WTRU B (step 1060). The handover commitment request message may be, for example, an MIH_Net_HO_Commit.request or a message. The handover commitment request message may indicate that WTRU B 1036 should be handed over to a different radio access network and/or frequency band. The handover commitment request message may indicate, for example, that WTRU B 1036 should handover to the radio access unit 1021 in Network Management Node B 1004.

Referring to FIG. 10B, WTRU B may, in response to the handover commitment request message, establish a new radio link with the radio access unit 1021 in Network Management Node B 1004 (step 1062). Upon successful establishment of the new radio link, WTRU B 1036 may send a handover commitment response message to Network Management Node B 1004 (step 1064). The handover commitment response message may be, for example, an MIH_MN_HO_Commit.response message.

In response to the handover commitment response message, Network Management Node B 1004 may send a resources commitment response message to Network Management Node A 1002 (step 1066). The resources commitment response message may be, for example, an MIH_N2N_HO_Commit.response message. WTRU B 1036 may perform an upper layer handover (step 1068). The radio access unit 1021 in Network Management Node B 1004 may participate in the upper layer handover.

WTRU B 1036 may send a handover complete request message to message to Management Node B 1004 to confirm completion of the handover (step 1070). The handover complete request message may be, for example, an MIH_MN_HO_Complete.request message. In response to the handover complete request message, Network Management Node B 1004 may release resources related to WTRU B 1036 (step 1072). This may include, for example, a AAA unit (not depicted) and/or the spectrum management unit 1025 in Network Management Node B 1004 modifying and/or deleting records related to WTRU B 1036.

Referring to FIG. 10C, Network Management Node B 1004 may send a handover complete response message to WTRU B 1036 to confirm completion of the handover (step 1074). The handover complete response message may be, for example, an MIH_MN_HO_Complete.response message. WTRU B 1036 may then perform a registration procedure with Network Management Node B 1004 (step 1076). The registration may be performed according the method of FIGS. 3A-3B, FIG. 4, and/or FIG. 5 (or any combination thereof), or according to a different registration procedure. The MIH server unit 1029, a AAA unit (not depicted), and/or spectrum management unit 1025 in Network Management Node B 1004 may participate in the registration procedure.

Network Management Node B 1004 may then send a handover complete request message to Network Management Node A 1002, to indicate that the requested radio resources have been made available (step 1078). The handover complete request message may be, for example, a n MIH_N2N_HO_Complete.request message. In response to the handover complete request message, Network Management Node A 1002 may send a handover complete response message to Network Management Node B 1004 (step 1080). The handover complete response message may be, for example, an MIH_N2N_HO_Complete.response message.

Network Management Node A 1002 may then send a handover commitment request message to WTRU A 1034 (step 1082). The handover commitment request message may, for example, an MIH_MN_HO_Commit.request message. The handover commitment request message may indicate that WTRU A 1034 should be handed over to a different radio access network and/or frequency band. The handover commitment request message may indicate, for example, that WTRU A 1034 should handover to the radio access unit 1020 in Network Management Node A 1002.

In response to the handover commitment request message, WTRU A 1034 may establish a radio link with the radio access unit 1020 at Network Management Node A 1002 (step 1084).

WTRU A 1034 may send a handover complete request message to Management Node B 1004 to confirm completion of the handover (step 1090). The handover complete request message may be, for example, an MIH_MN_HO_Complete.request message. In response to the handover complete request message, Network Management Node A 1002 may release resources related to WTRU B (step 1092). This may include, for example, a AAA unit (not depicted) and/or the spectrum management unit 1024 in Network Management Node A 1002 modifying and/or deleting records related to WTRU A 1034.

Network Management Node A 1002 may send a handover complete response message to WTRU A 1034 to confirm completion of the handover (step 1094). The handover complete response message may be, for example, an MIH_MN_HO_Complete.response message. WTRU A 1034 may then perform a registration procedure with Network Management Node A 1002 (step 1096). The registration may be performed according the method of FIGS. 3A-3B, FIG. 4, and/or FIG. 5 (or any combination thereof), or according to a different registration procedure. The MIH server unit 1028, a AAA unit (not depicted), and/or spectrum management unit 1024 in Network Management Node A 1002 may participate in the registration procedure.

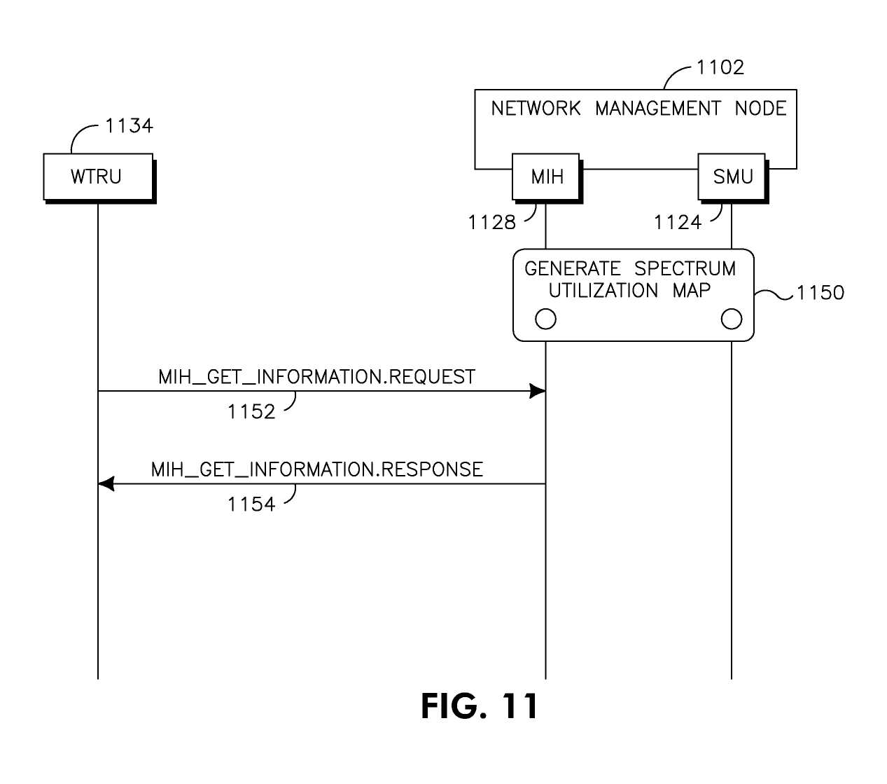

FIG. 11 shows an example method for the generation of a spectrum utilization map by a network management node 1102 and distribution of the spectrum utilization map to a WTRU 1134. The network management node 1102 may that include an MIH server unit 1128 and a spectrum management unit (SMU) 1124. A spectrum utilization map is a description of the spectrum usage in the network managed by the network management node 1102.

The method of FIG. 11 may begin with network management node 1102 generating a spectrum utilization map (step 1150). This may be performed by the MIH server unit 1128 and/or the spectrum management unit 1124 in the network management node 1102. This may be performed, for example, based on measurement reports received from WTRUs operating in the network managed by the network management node 1102. The measurement reports may be sent by the WTRUs according to measurement reporting configurations established during registrations with the network management node 1102. Alternatively or additionally, the spectrum utilization map may be based on sensing of WTRUs in the managed network of the network management node 1102. The sensing may be performed by and/or in conjunction with one or more radio access units (not depicted) in the network management node 1102 and/or one or more base stations (not depicted) with which the network management node 1102 is in communication. Alternatively or additionally, the spectrum utilization map may be based on information obtained from WTRUs during registration procedures with the network management node 1102. The network management node 1102 may store the generated spectrum utilization map in one or more computer-readable media (not depicted).

To obtain the spectrum utilization map, the WTRU 1134 may send an MIH_Get_Information.request message to the network management node 1102 (step 1152). The MIH_Get_Information.request message may indicate a request for the spectrum utilization map. The network management node 1102 may then determine if the WTRU 1134 is permitted to have access to the spectrum utilization map. If the WTRU 1134 is permitted to have access to the spectrum utilization map, the network management node 1102 may send the WTRU 1134 an MIH_Get_Information.response message that includes the spectrum utilization map (step 1154).

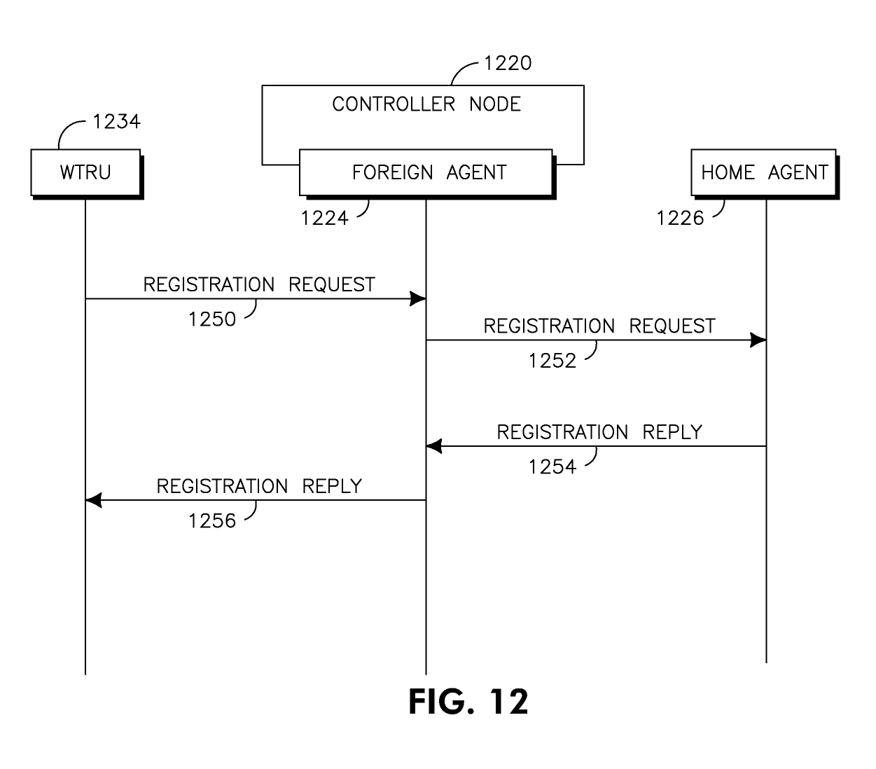

FIG. 12 shows an example method for upper-layer handover execution. FIG. 12 shows a WTRU 1234, a home agent 1226, and a controller node 1120 that includes a foreign agent 1224. The home agent 1126 may be included in or in communication with a core network (not depicted). The controller node 1220 may be in communication with one or more network management nodes (not depicted). The WTRU 1234, foreign agent 1224, and/or home agent 1226 may implement Mobile IP (MIP).

Before the method of FIG. 12 begins, the WTRU may have performed a lower-layer (Layer One and/or Layer Two) handover. The WTRU 1234 may send a registration request message to the foreign agent 1224 in the controller node 1220 (step 1250). In response to the registration request, the controller node 1220 may send a registration request message to the home agent (step 1252). In response to the registration request message, the home agent 1226 may send a registration reply message to the controller node 1220 (step 1254). In response to the registration reply message, the controller node 1220 may send a registration reply message to the WTRU 1234 (step 1256).

Each or any of the registration request messages and/or registration reply messages shown in FIG. 12 may be MIP messages. The method of FIG. 12 may be used to, for example, perform the handover of upper-layer (Layer Three and above) sessions when a WTRU moves between radio access networks. The handover of the upper-layer sessions may be continuous, such that service continuity in the upper-layer sessions is not interrupted.

The method of FIG. 12 may be used to perform an upper layer handover whenever an upper-layer handover is performed in any of the methods described above with reference to FIGS. 3-11. Alternatively or additionally, any other method for the transfer of upper-layer sessions between radio access networks may be used to perform upper-layer handovers as described above in the methods of FIGS. 3-11.

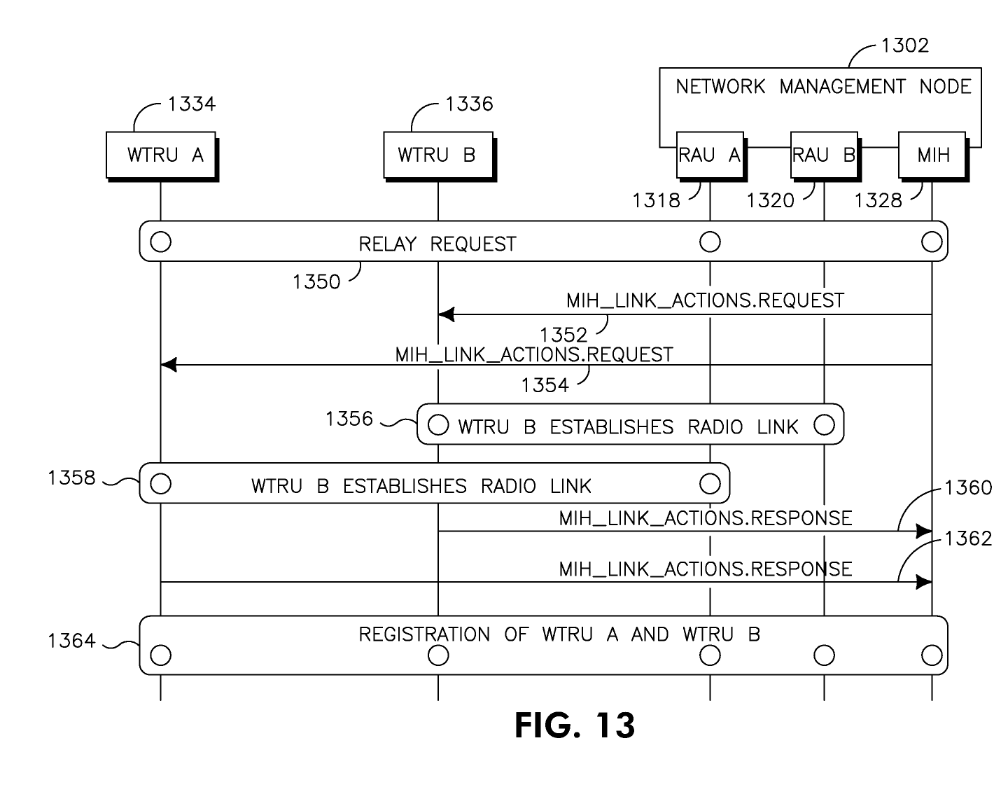

FIG. 13 shows an example method for the establishing a local data relay in a managed network, wherein the relay involves WTRUs 1334, 1336 that use different radio access technologies. FIG. 13 shows WTRU A 1334, WTRU B 1336, and a network management node 1302. The network management node 1302 may include include Radio Access Unit A (RAU A) 1318, Radio Access Unit B (RAU B), and MIH server 1328. WTRU A 1334 and WTRU B 1336 may operate using different radio access technologies.

The method of FIG. 13 may begin with WTRU A 1334 sending a relay request to the network management node 1302 (step 1350). This may be performed, for example, during a registration of WTRU A 1334 with the network management node 1302. The relay request may indicate that WTRU A would like to communicate with WTRU B 1336.

The network management node 1302 may make a determination as to whether the network management node 1302 should grant the relay quest. If the network management node 1302 makes a determination to grant the request, the network management node 1302 may send MIH_Link_Actions.request messages to WTRU B 1336 and to WTRU A 1334 (step 1352, step 1354). The MIH_Link_Actions.request messages request that the WTRUs 1334, 1336 establish radio links. Each or both of the MIH_Link_Action.request messages may include one or more fields indicating the target radio access network and/or target base station or radio access unit, on which the new radio link should be established. This information may be included, for example, in a TargetLinkAdd field in the MIH_Link_Action.request messages. The MIH_Link_Actions.request message to WTRU B 1336, for example, may request that WTRU B 1336 establish a radio link to Radio Access Unit B 1320. The MIH_Link_Actions.request message to WTRU A 1334, for example, may request that WTRU A 1334 establish a radio link to Radio Access Unit B 1318.

WTRU B 1336 may then establish a radio link to Radio Access Unit B 1320 (step 1356), and WTRU A may then establish a radio link to Radio Access Unit A (step 1358). The established radio links may be based on different radio access technologies.

WTRU B 1336 and WTRU A 1334 may then send MIH_Link_Actions.response messages to the network management node 1302 (step 1360, step 1362) to confirm the establishment of the radio links. After these messages are transmitted, a relay at the network management node is formed. In the relay, data may be communicated by WTRU A 1334 to Radio Access Unit A 1318 using a first radio access technology. Radio Access Unit A 1318 then communicates the data to Radio Access Unit B 1320. Radio Access Unit B 1320 then communicates the data to WTRU B 1336. Data may be communicated from WTRU B 1336 to WTRU A 1334 in the reverse order.

WTRU A 1034 and WTRU B 1036 may then perform registration procedures with the network management node 1302 (step 1364). The registration procedures may be performed according the method of FIGS. 3A-3B, FIG. 4, and/or FIG. 5 (or any combination thereof), or according to different registration procedures.

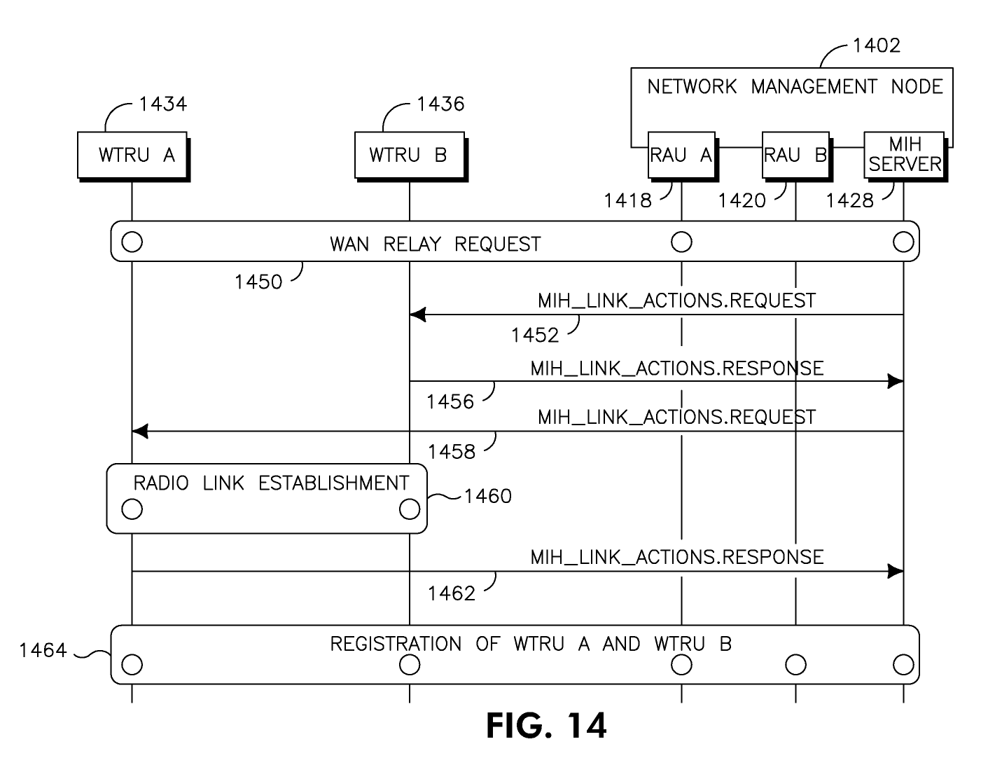

FIG. 14 shows an example method for establishing a WAN relay connection in a managed network. FIG. 14 shows WTRU A 1434, WTRU B 1436, and a network management node 1402. The network management node 1402 may include Radio Access Unit A 1418, Radio Access Unit B 1420, and MIH server unit 1426. In the example method of FIG. 14, WTRU A 1434 may not have WAN access capabilities and/or may not have current access to a WAN. WTRU B 1436, however, may be able to access a WAN. As described in further detail below, WTRU A 1434 may be able to establish a relay to WTRU B 1436, and communicate data to/from the WAN via WTRU B 1436.

The method of FIG. 14 may begin with WTRU A 1434 sending a WAN relay request to the network management node 1402 (step 1450). This may be performed, for example, during a registration of WTRU A 1434 with the network management node 1402. The relay request may indicate that WTRU A would like to use WTRU B 1436 as a WAN relay.

The network management node 1402 may make a determination as to whether the network management node 1402 should grant the relay quest. This may be based on, for example, whether a WTRU is available to fulfill the WAN relay request. If more than one WTRU is available to fulfill the request, this may further involve selecting a WTRU from the available WTRUs, based on one or more factors such as link conditions at the available WTRUs. If the network management node 1402 makes a determination to grant the request, the network management node 1402 may send an MIH_Link_Actions.request message to a selected WTRU (step 1452), such as WTRU B 1436. The MIH_Link_Action.request message may include one or more fields indicating the target device to which a new radio link should be established. This information may be included, for example, in a TargetLinkAdd field in the MIH_Link_Action.request message. The MIH_Link_Actions.request message, for example, may indicate to WTRU B 1436 that it should establish a radio link with WTRU A 1434. In response to the MIH_Link_Actions.request message, WTRU B 1436 may send an MIH_Link_Actions.response message to the network management node 1402 (step 1456).

In response to the MIH_Link_Actions.response message, the network management node 1402 may send an MIH_Link_Actions.request message to WTRU A 1434 (step 1458). The MIH_Link_Action.request message may include one or more fields indicating the target device to which a new radio link should be established. This information may be included, for example, in a TargetLinkAdd field in the MIH_Link_Action.request message. The MIH_Link_Actions.request message may indicate, for example, that WTRU A 1434 should establish a radio link with WTRU B 1436.

WTRU A 1434 and WTRU B 1436 may then establish a radio link (step 1460). The radio link may be based on a local area network technology such as WLAN, Bluetooth, IEEE 802.15, Zigbee, and/or any other technology that supports WTRU-to-WTRU communication. Once the radio link is established, WTRU A 1434 may communicate data with a WAN via WTRU B 1436.

WTRU A 1434 may then send an MIH_Link_Actions.response message to the network management node 1402 (step 1462). After establishment of the radio link WTRU A 1434 and WTRU B 1436 may perform registration procedures with the network management node 1402 (step 1464). The registration procedures may be performed according the method of FIGS. 3A-3B, FIG. 4, and/or FIG. 5 (or any combination thereof), or according to different registration procedures.

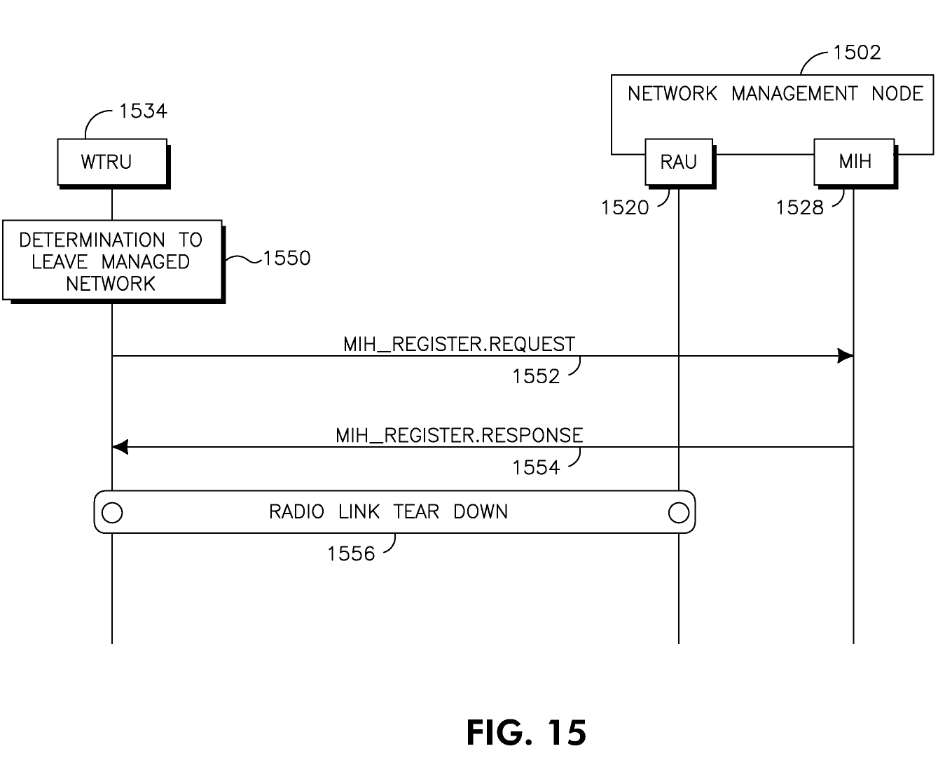

FIG. 15 shows an example method for the deregistration of a WTRU 1534 with a network management node 1502. FIG. 15 shows a WTRU 1534 and a network management node 1502 that includes a radio access unit (RAU) 1520 and an MIH server unit 1526. Before the method of FIG. 15 begins, the WTRU 1534 may have a radio link to the radio access unit 1520.

The method of FIG. 15 may begin with the WTRU 1534 making a determination that that it is leaving the network managed by the network management node 1502 (step 1550). The WTRU may send a deregistration message to the network management node 1502 (step 1552). The deregistration message may be, for example, an MIH_Register.request message. The deregistration message may indicate that the WTRU 1534 is deregistering from the network management node 1502 and/or that the WTRU 1534 is planning to tear down the radio link to the radio access unit 1520. The deregistration message may also indicate a request for the network management node 1502 to preserve information related to the whether the WTRU 1534 for future use. The deregistration message may also specify which types of information the network management node 1502 may maintain for future use.

In response to the MIH_Register.request message, the network management node 1502 may send deregistration response message to the WTRU 1534 (step 1554). The deregistration response message may be, for example, an MIH_Register.response message. The deregistration response message may indicate an acknowledgement that the WTRU 1534 is deregistering from the network management node 1502 and/or an acknowledgment that the WTRU 1532 will be tearing down the radio link to the radio access unit 1520. The WTRU 1534 and/or the radio access unit 1520 may then tear down the radio link (step 1556).

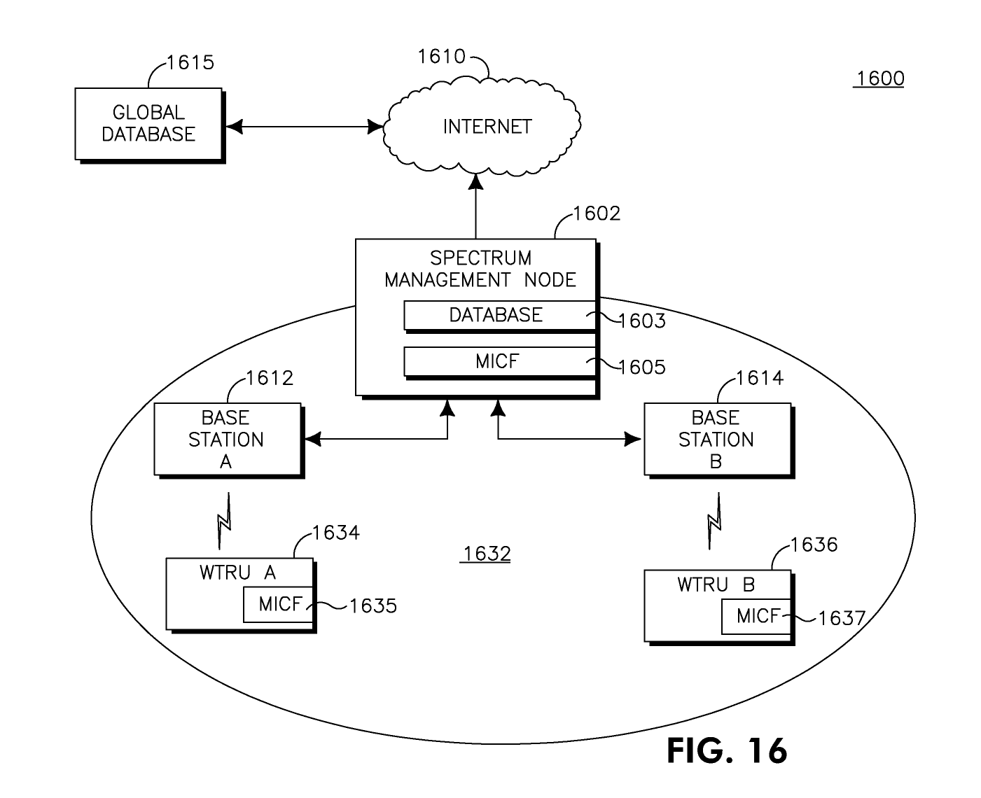

FIG. 16 shows an example architecture 1600 for the management of spectrum usage in the context of white space-capable WTRUs 1634, 1636. In addition to WTRU A 1634 and WTRU B 1636, the example architecture 1600 may include a spectrum management node 1602 and a managed area 1632 that is managed by the spectrum managed node 1602. The managed area 1632 may include Base Station A 1612, which may be in communication with WTRU A 1634. The managed area 1632 may also include Base Station B 1614, which may be in communication with WTRU B 1636. The managed area may include any number of base stations that operate using wide-area radio access network technologies, and/or any number of base stations that operate using local-area radio access network technologies. Base Station A 1612 and/or Base Station B 1614 may operate, for example, using WLAN, IEEE 802.16, and/or any other type of radio access technology.

The example architecture may also include the Internet 1610 and global database 1615. The global database 1615 may include location information for licensed and unlicensed white space-capable WTRUs. The global database 1615 may be maintained by a government entity such as, for example, the FCC. The global database 1615 may include information related to white space-capable WTRUs, such as but not limited to location information, identification information, and/or capability information of white space-capable WTRUs. A white-space capable WTRU may query the global database 1615 to obtain a list of frequency bands available for operation at the WTRU's location. The global database 1615 will first check to determine that the querying WTRU is appropriately registered with the global database 1615. If the WTRU is registered, the global database 1615 will determine if spectrum is available for the WTRU at the WTRU's location. In doing so, the global database 1615 may take into account licensed white space-capable base stations and WTRUs in proximity of the querying WTRU, to determine what frequency bands are available for the WTRU. The global database 1615 may then return a list of available frequency bands with allowed power levels to the WTRU.

The spectrum management node 1602 may communicate with the WTRUs 1634, 1636 in the managed area 1632 via Base Station A 1612 and Base Station B 1614. Base Station A 1612 and Base Station B 1614 may operate using different radio access technologies. In various implementations, Base Station A 1612 and/or Base Station B 1614 may communicate with the spectrum management node 1602 via the Internet. Alternatively or additionally, Base Station A 1612 and/or Base Station B 1614 may be in communication via a local network.

The spectrum management node 1602 may include a Media Independent Coexistence (MIC) Function (MICF) 1605, which provides provide Media Independent Coexistence (MIC) services to the WTRUs 1634, 1636 in the managed area 1632. MIC includes three sub-services: a MIC event service, related to the communication of environment sensing messages; a MIC command service, related to the providing commands to WTRUs regarding which frequency bands they should use; and a MIC information service, related to the communication of data to and/or from the global database 1615. The WTRUs 1634, 1636 in the managed area 1632 may also include MICFs 1635, 1637. MIC messages may be transmitted between the MICF 1605 at the spectrum management node 1602 and the MICFs 1635, 1637 at the WTRUs 1634, 1636 using the MIH protocol. The MICFs 1635, 1637 at the WTRUs 1634, 1636 may receive, process, and respond to MIC messages from the MICF 1605 at the spectrum management node 1602. A MICF 1605, 1635, 1637 may be implemented as a circuit, combination of circuits, a software module, a firmware module, or as a combination of software, firmware, and/or one or more circuits.

According to MIC, the spectrum management node 1602 may perform proxy functions on behalf of the WTRUs 1634, 1636, and interact with the global database 1615 on behalf of the WTRUs 1634, 1636. The spectrum management node may, for example, perform one or more of the following functions: performing proxy registrations of the WTRUs 1634, 1636 with the global database 1615; sending messages to the WTRUs 1634, 1636 in the managed area 1632 regarding whether the WTRUs are permitted to use shared spectrum; sending messages to the WTRUs 1634, 1636 in the managed area related to disablement and/or relocation; sending global update information from the global database 1615 to the WTRUs 1634, 1636; distribution to the WTRUs 1634, 1636 of information related to other WTRUs (not depicted) sharing spectrum in the managed area 1632; distribution of inter-radio access technology coexistence policies; sending information to WTRUs 1634, 1636 to control spectrum usage, so as to optimize the usage of shared spectrum among unlicensed users; and sending coexistence sensing commands related to synchronized quieting and sensing measurements.

The spectrum management node 1602 may maintain a local database 1603. The local database 1603 may include MIC policies. A MIC policy may indicate how spectrum should be allocated to a WTRU on different radio access technologies. For example, a MIC policy may indicate that a WTRU on a first radio access technology will or will not defer to a WTRU on a second radio access technology. Alternatively or additionally, a MIC policy may indicate that a WTRU on a first radio access technology may timeshare with a WTRU on a second radio access technology.

The local database 1603 may contain the contents of the global database 1615 or a subset thereof. If the local database 1603 contains a subset of the database in the global database 1615, the contents may be limited to, for example, the areas and frequencies relevant to the managed area 1632. According to MIC, the spectrum management node 1602 may send queries to the global database 1615, and may update the local database 1603 based on the responses to the queries. Alternatively or additionally, the spectrum management node 1602 may receive updates of data from the global database 1615 related to WTRUs 1634, 1636 operating in the managed area 1632. The spectrum management node 1602 may also send data to the global database 1615 regarding WTRUs 1634, 1636 in the managed area 1632.

Alternatively or additionally, the local database 1603 may include data related to the WTRUs 1634, 1636 in the managed area 1632. For each WTRU 1634, 1636 in the managed area 1632, the local database 1603 may include information related to one or more of the following: a client or WTRU identifier; an enabling station (STA) identifier; a location of the WTRU; an indication of the accuracy of the location information for the WTRU; a radio access technology used by the WTRU; a center frequency used by the WTRU; maximum bandwidth used by the WTRU; a maximum transmit power for the WTRU; an access initation time; and access termination time (if scheduled); a Media Access Control (MAC) address for the WTRU; a MAC address of a base station with which the WTRU is in communication; radio capabilities of the WTRUs; radio access technologies supported by the WTRU; frequencies supported by the WTRU; data rates supported by the WTRU; services supported by the WTRU; a description of mobility status of the WTRU (for example, whether the WTRU is in a fixed location, traveling at a low speed, or traveling at a high speed); power status of the WTRU (for example, whether it has unlimited power capacity, has more than one hour's power reserve, less than one hour's power reserve); sending and/or measurement capabilities of the WTRU; and antenna capabilities of the WTRU.

The WTRUs 1634, 1636 in the managed area may provide event-driven MIC notifications to the spectrum management node 1602. For example, the WTRUs 1634, 1636 may send messages to the spectrum management node 1602 indicating that one or more of the following events have occurred: that the location of a WTRU 1634, 1636 has changed; that a WTRU 1634, 1636 has detected the onset or termination of interference which may limit communication; or that a WTRU 1634, 1636 has detected the presence of a licensed WTRU (not depicted) in the managed area 1632.

MIC may further include maintaining data related to channel usage in the managed area 1632. For example, MIC may include the tracking of vacant channels areas in the managed area (wherein “vacant” means that no know WTRUs are operating on the channels), the tracking of available channel areas in the managed area (wherein “available” means that no know licensed WTRUs are operating on the channels), and/or the tracking of all unavailable channel areas in the managed area 1632 (wherein “unavailable” means within an interference range of a licensed WTRU). MIC may further include controlling WTRU operation. For example, MIC may include one or more of: disabling or relocating WTRUs to meet regulator requirements; handovers of WTRUs between different base stations (in the same radio access technology or between different radio access technologies) in the managed area 1632 so as to decrease inter-WTRU interference; using inter-radio access technology spectrum sharing policies; coordinating channel quieting and sensing across all radio access technologies and WTRUs in the managed area 1632; providing WTRUs with updated descriptions of shared spectrum users; or facilitating communication between WTRUs operating in different radio access technologies to resolve coexistence issues. Any or all of these functions may be performed by one or more of the spectrum management node 1602, WTRU A 1634, and/or WTRU B 1636.

In various implementations, the managed area 1632 may overlap with the one or more other managed areas (not depicted) managed by other spectrum management nodes (not depicted). In such an instance, the network management nodes may synchronize with the other network management nodes that share coverage areas.

Although FIG. 16 shows that WTRU A 1634 and WTRU B 1636 may include MIHFs 1635, 1637, in various implementations, a WTRU may interact with the spectrum management node 1602 without including an MICF. Alternatively or additionally, a base station (such as Base Station A 1612 and/or Base Station B 1614) may include an MICF and act as MICF proxies to their respective WTRUs 1634, 1636.

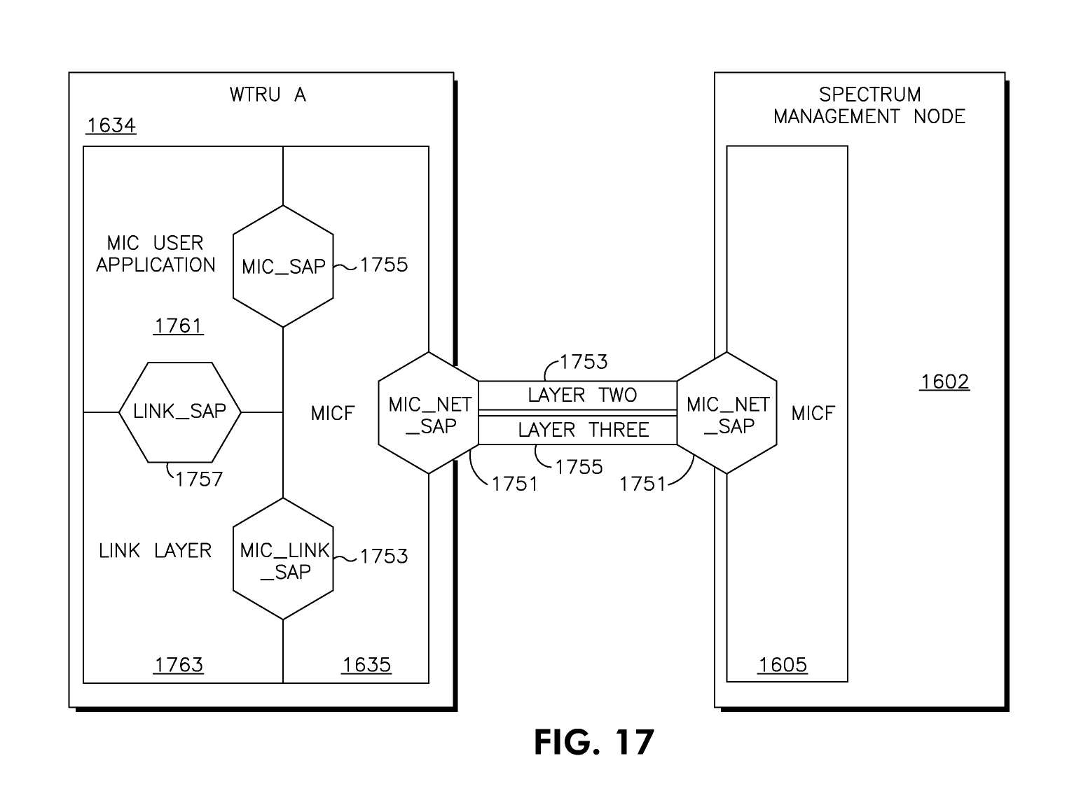

FIG. 17 provides a further detailed view of how MIC may be implemented in the spectrum management node 1602 and WTRU A 1634. FIG. 17 shows the spectrum management node 1602, which include a MICF 1605. WTRU A 1634 includes an MICF 1635, as well as a MIC User Application 1761 and a link layer unit 1763.

The MIC User Application 1761 may be, for example, an application running on WTRU A 1634 at the application layer or above. The link layer unit 1763 may be a transceiver, a component of a transceiver, one or more circuits, or any combination of circuits, firmware, and/or software configured to implement Layer One and/or Layer two interfaces for a radio access technology.

The MICF 1635 and the link layer unit 1763 may communicate MIC-related data via the MIC LINK Service Access Point (SAP) (MIC_LINK_SAP) 1753. The MICF 1635 and the MIC User Application may communicate MIC-related data via the MIC_SAP 1755. The MIC user application 1761 and the link layer unit 1757 may communicate media-specific data using the LINK_SAP 1757. The MICF 1635 in WTRU A 1634 and the MICF 1605 in the spectrum management node 1602 may communicate MIC-related data via the MIC_NET_SAP 1751. The MIC_NET_SAP may be used to communicate data at Layer Two 1753 and/or Layer Three 1759 or above.

Each or any of the of the SAPs 1751, 1753, 1755, 1757 may be an addressable interface between the components 1605, 1635, 1763, 1761 that communicate using the SAPs 1751, 1753, 1755, 1757. A SAP 1751, 1753, 1755, 1757 may be implemented as one or more circuits, software, firmware, or any combination of circuits, firmware, and/or software that may be used to communicate data between the respective components 1605, 1635, 1761, 1763 involved in the SAP 1751, 1753, 1755, 1757. Communication on the MIC SAPs 1751, 1753, 1755 may be performed using MIH protocols, MIH messages, and/or other MIC-specific protocols and/or messages, and/or other protocols. The data communicated on the MIC SAPs 1751, 1753, 1755 may include any combination of the MIC-related messages and/or MIC-related data as described above with reference to FIG. 16, including but not limited to data related to the MIC event service, the MIC command service, and/or the MIC information service.

A base station may also implement one or more of the SAPs described above with reference to WTRU A 1634 in FIG. 17. For example, a base station may include a MIC_SAP, a MIC_LINK_SAP, a LINK_SAP, and/or a MIC_NET_SAP, each or any of the SAPs having features similar to those described above with reference to the SAPs 1751, 1753, 1755, 1757 in WTRU A 1634. A base station may, for example, communicate with a spectrum management node (such a Spectrum Management Node 1602) via a MIC_NET_SAP or other SAP.

In various implementations, a network node may include any feature and/or implement any functionality attributed to one or any combination of network nodes 102, 104, 106, 302, 402, 502, 602, 702, 802, 902, 1002, 1004, 1102, 1220, 1302, 1402, 1502 described above with reference to FIGS. 1-15, and/or include any feature and/or implement any functionality attributed to the spectrum management node 1602 described above with reference to FIGS. 16-17. In various implementations, a WTRU may include any feature and/or implement any functionality attributed to one or any combination of WTRUs 134, 136, 138, 144, 146, 148, 334, 434, 634, 734, 834, 934, 936, 1034, 1036, 1134, 1234, 1334, 1336, 1434, 1436, 1534 described above with reference to FIGS. 1-15, and/or include any feature and/or implement any functionality attributed to one or any combination of WTRUs 1634, 1636 described above with reference to FIGS. 16-17.

Any or all of the WTRUs 134, 136, 138, 144, 146, 148, 334, 434, 634, 734, 834, 934, 936, 1034, 1036, 1134, 1234, 1334, 1336, 1434, 1436, 1534, 1634, 1636 described above with reference to FIGS. 1-17 may include an MIH client or an MIH function (MIHF), configured to transmit, receive, generate, and/or process the MIH messages described above with reference to FIGS. 1-17. An MIH client or an MIHF may be implemented as a processor, combination of processors, a software module, a firmware module, or as a combination of software, firmware, and/or one or more processors.

Although examples are provided above with reference to FIGS. 1-17 with reference to the MIH protocol, in various implementations, any protocol may be substituted for the MIH protocol. Alternatively or additionally, for any MIH message described above with reference to FIGS. 1-17, any message according to a different standard or format may be used.

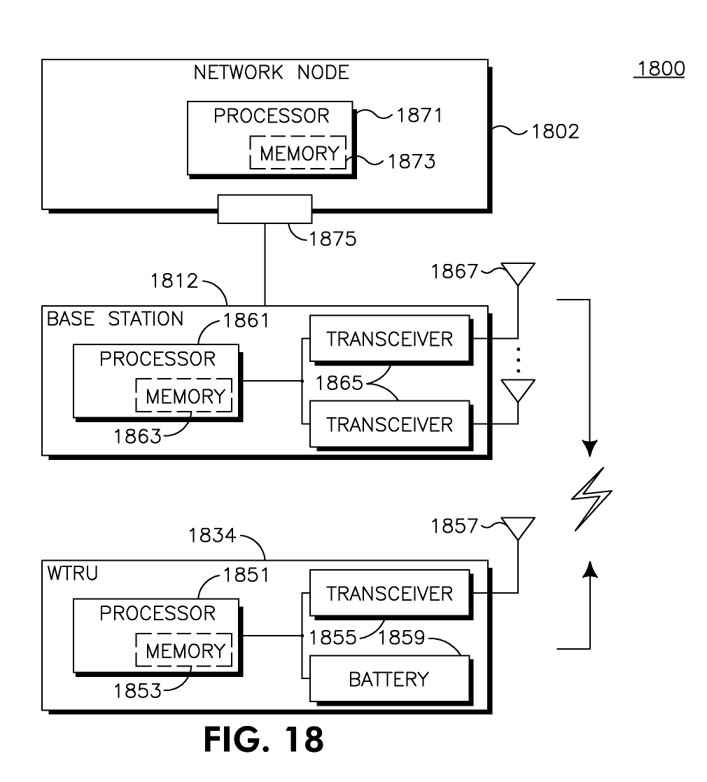

FIG. 18 shows an example wireless communication system 1800 that may be configured to implement the features and methods described above with reference to FIGS. 1-17. The wireless communication system may include a WTRU 1834, a base station 1812, and a network node 1802.

In addition to the components that may be found in a typical WTRU, the WTRU 1834 may include a processor 1851 with a linked memory 1861, a transceiver 1881, a battery 1859, and an antenna 1857. The processor 1851 may be configured to generate and/or process messages and other data as described above with reference to FIGS. 1-17. The transceiver 1881 is in communication with the processor 1851 and the antenna 1857 to facilitate the transmission and reception of wireless data. In case a battery 1859 is used in the WTRU 1834, it may power the transceiver 1855 and/or the processor 1851. In addition to the transceiver 1855 shown in FIG. 18, the WTRU 1834 may include one or more additional transceivers (not depicted). The transceiver 1855 may be a single-mode transceiver, or may be a multi-mode transceiver that is capable of communicating using two or more different RATs. The one or more additional transceivers (not depicted) may also each be single- or multi-mode transceivers. The WTRU may additionally include an MIH client (not depicted), MIHF, and/or an MIC client (not depicted). The WTRU 1834 may be capable of performing functionality attributed to one or any combination of WTRUs 134, 136, 138, 144, 146, 148, 334, 434, 634, 734, 834, 934, 936, 1034, 1036, 1134, 1234, 1334, 1336, 1434, 1436, 1534, 1634, 1636 described above with reference to FIGS. 1-17.

In addition to the components that may be found in a typical base station, the base station 1812 may include a processor 1861 with a linked memory 1863, transceivers 1865, and antennas 1867. The processor 1861 may be configured to generate and/or process messages and/or other data as described above with reference to FIGS. 1-17. The transceivers 1865 are in communication with the processor 1861 and antennas 1867 to facilitate the transmission and reception of wireless data. Although the base station 1812 of FIG. 18 is shown having two or more transceivers 1865 and two or more antennas 1867, a base station 1812 may include any number of transceivers 1865 and/or antennas 1867, including one or more transceivers 1865 and/or one or more antennas 1867. The base station 1812 may be capable of performing functionality attributed to any base station, radio access unit, or any combination of any base stations and/or radio access units described above with reference to FIGS. 1-17.

The network node 1802 may include a processor 1871 and a linked memory 1873. The network node 1802 may include a communications interface 1875, which is configurable to transmit and/or receive data to/from the base station 1812 and/or other network nodes (not depicted). The communications interface 1875 may be or include a transceiver. The communications interface 1875 may operate using wired and/or wireless communications technology. The communications interface 1875 may be capable of communicating with the base station 1812 and/or other network nodes based on technologies such as, for example, Ethernet, Carrier Ethernet, fiber optics, microwave, xDSL (Digital Subscriber Line), Asynchronous Transfer Mode, (ATM), Signaling System 7 (SS7), Internet Protocol (IP), and/or IP/Multiprotocol Label Switching (MPLS). and/or antennas (not depicted). The network node may be capable of implementing functionality attributed to one or any combination of network nodes 102, 104, 106, 302, 402, 502, 602, 702, 802, 902, 1002, 1004, 1102, 1220, 1302, 1402, 1502, 1602 described above with reference to FIGS. 1-17. The processor 1871 may be configured to generate and/or process messages and other data as described above with reference to FIGS. 1-17. In addition to the features described above, the network node 1802 may implement base station functionality. In such an instance, the network node 1802 may include one or more wireless transceivers (not depicted), which may be in communication with the processor 1871 to facilitate the transmission and reception of wireless data.

Although examples are provided above with reference to FIGS. 1-18 in terms of specific radio access technologies, the principles described above are applicable to any or any combination of radio access technologies. The principles described above with reference to FIGS. 1-18 are applicable to wireless communications systems that are based on technologies such as LTE, LTE-Advanced (LTE-A), SAE, UTRAN, UMTS, IEEE 802.16/WiMax, Wireless Broadband (WiBro), GSM, Enhanced Data Rates for GSM Evolution (EDGE) Radio Access Network (GERAN), IEEE 802.11x/WLAN, CDMA2000, IEEE 802.15, Zigbee, and/or any other technology that supports the features and methods described above with reference to FIGS. 1-18.

As used herein, the term “processor” includes, but is not limited to, a general purpose processor, a special purpose processor, a conventional processor, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used herein, the term “circuit” includes any single electronic component of combination of electronic components, either active and/or passive, that are coupled together to perform one or more functions. A circuit may be composed of components such as, for example, resistors, capacitors, inductors, memristors, diodes, or transistors. Examples of circuits include but are not limited to a microcontroller, a processor, and a transceiver.

As used herein, the term “computer-readable medium” includes, but is not limited to, a cache memory, a read-only memory (ROM), a semiconductor memory device such as a D-RAM, S-RAM, or other RAM, a magnetic medium such as a flash memory, a hard disk, a magneto-optical medium, an optical medium such as a CD-ROM, a digital versatile disk (DVD), or Blu-Ray disc (BD), other volatile or non-volatile memory, or any electronic data storage device.

As used herein, the terms “software module” and “firmware module” include, but are not limited to, an executable program, a function, a method call, a procedure, a routine or sub-routine, an object, a data structure, or one or more executable instructions. A “software module” or a “firmware module” may be stored in one or more computer-readable media.

Although features and elements are described above with reference to FIG. 1-18 in particular combinations, each feature or element can be used alone without the other features and elements or in various combinations with or without other features and elements. The sub-elements of the methods or flowcharts described above with reference to FIG. 1-18 may be realized in any order (including concurrently), in any combination or sub-combination. The methods or flow charts described above with reference to FIGS. 1-18 may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for use in a network node, the method comprising:
receiving a service request from a wireless transmit/receive unit (WTRU);
in response to the service request, sending a first message to a second network node, wherein the first message indicates a request that the second network node make a frequency band available;
receiving a second message from the second network node, wherein the second message indicates that the second network node has made the frequency band available; and
sending a third message to the WTRU, wherein the third message indicates that the WTRU should communicate data on the frequency band.

2. The method of claim 1, further comprising:
sending a fourth message to the second network node, wherein the fourth message indicates a query as to whether the second network node can make the frequency band available; and
receiving a fifth message from the second network node, indicating that the second network node can make the frequency band available;
wherein the sending the first message to the second network node is performed further in response to the fifth message.

3. The method of claim 1, wherein the service request is received via a radio access network, and wherein the sending the first message to the second network node is performed further in response to a determination that radio conditions on the radio access network do not support the service request.

4. The method of claim 3, further comprising:
receiving a measurement report indicating radio conditions on the radio access network;
wherein the determination that radio conditions on the radio access network do not support the service request is based on the measurement report.

5. The method of claim 1, wherein the service request is received via a first radio access network, and wherein the third message indicates that the WTRU should handover to a second radio access network.

6. The method of claim 1, wherein the second message is an MIH_N2N_HO_Complete.request message.

7. The method of claim 1, wherein the frequency band is a white space frequency band.

8. A method for use in a network node, the method comprising:
receiving a service request from a wireless transmit/receive unit (WTRU);
evaluating spectrum usage on a first radio access network;
in response to the evaluation, causing a frequency band currently in use to become available; and
sending a first message to the WTRU, wherein the first message indicates that the WTRU should communicate data on the frequency band.

9. The method of claim 8, wherein the causing the frequency band to become available includes sending a second message to a second network node, wherein the second message indicates a request that the second network node make the frequency band available.

10. The method of claim 9, further comprising:
receiving a third message from the second network node, wherein the third message indicates that the second network node has made the frequency band available.

11. The method of claim 8, wherein the causing the frequency band to become available includes moving a second WTRU from the frequency band to a second frequency band.

12. The method of claim 8, wherein the first message indicates that the WTRU should handover to a second radio access network.

13. The method of claim 8, wherein the first message is an MIH_MN_HO_Commit.request message.

14. The method of claim 8, wherein the frequency band is a white space frequency band.

15. A network node comprising:
a processor configured to make a determination to handover a Peer-To-Peer (P2P) group of wireless transmit/receive units (WTRUs) from a first radio access network to a second radio access network; and
a transmitter configured to send handover messages to the WTRUs in the P2P group, the handover messages indicating that the WTRUs in the P2P group should handover to the second radio access network.

16. The network node of claim 15 wherein the processor is configured to make the determination to handover the P2P group based on an initiation of an application by at least one WTRU in the P2P group.

17. The network node of claim 15 wherein the processor is configured to make the determination to handover the P2P group based on Quality of Service (QoS) requirements of WTRUs in the P2P group.

18. The network node of claim 15 wherein the processor is configured to make the determination to handover the P2P group based on radio conditions on the first radio access network.

19. The network node of claim 18 further comprising:
a receiver configured to receive a measurement report indicating radio conditions on the first radio access network;
wherein the determination to handover the P2P group based on radio conditions is based on the measurement report.

20. The network node of claim 15, wherein at least one of the handover messages is an MIH_MIH_Net_HO_Commit.request message.
